(19) United States
(12) Patent Application Publication
(10) Pub. No.: US 2005/0286916 A1
(43) Pub. Date: Dec. 29, 2005

(54) Recording medium conveyance failure occurrence predicting apparatus, fixing device, image forming apparatus, and recording medium conveyance failure occurrence predicting method

(76) Inventors: Yasushi Nakazato, Tokyo (JP); Hisashi Shoji, Kawasaki-shi (JP); Satoshi Ouchi, Tokyo (JP); Osamu Satoh, Sagamihara-shi (JP); Shuji Hirai, Tokyo (JP); Yoshinori Nakagawa, Yokohama-shi (JP); Nekka Matsuura, Yokohama-shi (JP); Seiji Hoshino, Atsugi-shi (JP); Katsuaki Miyawaki, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/167,821

(22) Filed: Jun. 28, 2005

(30) Foreign Application Priority Data
Jun. 28, 2004 (JP) JPAP2004-190282

(51) Int. Cl. G03G 15/00

(52) U.S. Cl. 399/16

(57) ABSTRACT

A recording medium conveyance failure occurrence predicting apparatus predicts an occurrence of a conveyance failure of a recording medium conveyed in a conveyance path in an image forming apparatus including a recording medium conveyance member that conveys the recording medium while moving and contacting the recording medium, and a separation portion where the recording medium is separated from the recording medium conveyance member. The recording medium conveyance failure occurrence predicting apparatus includes a recording medium abnormal separation detecting unit that detects an abnormal separation of the recording medium from the recording medium conveyance member, and a determining unit that predicts an occurrence of a conveyance failure of the recording medium in the separation portion based on a detection result of the recording medium abnormal separation detecting unit.

### CROSS-REFERENCE TO RELATED APPLICATIONS

This application claims priority to Japanese Patent Application No. 2004-190282 filed in the Japanese Patent-Office on Jun. 28, 2004, the entire contents of which is hereby incorporated by reference herein.

### BACKGROUND OF THE INVENTION

1. Field of the Invention

The present invention relates to a recording medium conveyance failure occurrence predicting apparatus and a recording medium conveyance failure occurrence predicting method for predicting an occurrence of a conveyance failure of a recording medium conveyed in a conveyance path in an image forming apparatus, and to an image forming apparatus including the recording medium conveyance failure occurrence predicting apparatus. The present invention further relates to a fixing device including a detecting unit for predicting an occurrence of a conveyance failure of a recording medium, and to an image forming apparatus including the fixing device.

2. Discussion of the Background

In an image forming apparatus that forms an image on a recording medium such as a sheet, an image formed in an image forming section is transferred to a recording medium conveyed along a conveyance path from a recording medium containing section or an external apparatus, and is then fixed on the recording medium. The recording medium having a fixed image is discharged from the image forming apparatus. During the operation of the image forming apparatus, a conveyance failure such as a sheet jam typically occurs due to some reasons.

Conventionally, when a sheet jam occurs in an image forming apparatus, an image forming operation of the image forming apparatus is automatically interrupted in accordance with a detection signal of a jam detecting unit. Then, the jammed sheet is removed from a main body of the apparatus to restore the apparatus to a normal image forming state.

In a jammed sheet removing operation, a sheet jammed in a sheet feeding section and a sheet jammed in a heat fixing device need to be removed manually. To remove ajammed sheet easily and efficiently, for example, Published Japanese patent application Nos. 2004-170442 and 2004-170848 proposed sheet removing techniques.

The causes of an occurrence of a sheet jam in an image forming apparatus may be divided broadly into two types. In the first type, a sheet jam is caused by an inadequate operation of a user, such as a sheet setting failure, and a use of an irregular sheet such as a thick or thin sheet. In the second type, a sheet jam is caused by component parts deteriorating over time and faults which exert a negative influence on a sheet conveyance performance.

In the first type, an image forming apparatus can be operated again by removing a jammed sheet from a sheet conveyance path. However, in the second type, even though a jammed sheet is removed from a sheet conveyance path, a sheet jam may occur again soon and an image forming operation may not be performed. In the case of a sheet jam caused by deteriorated component parts and faults, maintenance needs to be performed to replace the deteriorated component parts and to repair the faults. When performing the maintenance, all or some of the functions of the apparatus need to be halted from a disabled condition due to the deteriorated component parts to the replacement of the component parts, or from the occurrence of the faults to the completion of repairs, causing a great time loss for a user.

Therefore, if an occurrence of a conveyance failure such as a sheet jam is predicted, and if necessary maintenance is performed in advance, the amount of downtime can be reduced.

### SUMMARY

According to an aspect of the present invention, a recording medium conveyance failure occurrence predicting apparatus predicts an occurrence of a conveyance failure of a recording medium conveyed in a conveyance path in an image forming apparatus including a recording medium conveyance unit including a record medium conveyance member that comes into contact with the recording medium while moving the recording medium. The record medium conveyance unit further includes a separation portion that provides normal separation of the recording medium from the recording medium conveyance member with resulting recording medium movement along a desired track. The recording medium conveyance failure occurrence predicting apparatus also includes a recording medium abnormal separation detecting unit that detects an abnormal separation or lack of separation of the recording medium from the recording medium conveyance member such that recording medium movement is not along the desired track and a determining unit that predicts a probable future abnormal separation or lack of separation of the recording medium from the recording medium conveyance member based at least on a detection result of the recording medium abnormal separation detecting unit.

According to another aspect of the present invention, a recording medium conveyance failure occurrence predicting apparatus predicts an occurrence of a conveyance failure of a recording medium conveyed in a conveyance path in an image forming apparatus including a recording medium conveyance unit including a recording medium conveyance member that comes into contact with the recording medium while moving the recording medium. The recording medium conveyance unit further includes a separation portion that provides normal separation of the recording medium from the recording medium conveyance member with resulting recording medium movement along a desired track. The recording medium conveyance failure occurrence predicting apparatus also includes an information obtaining unit that obtains plural types of information related to a state of the image forming apparatus, an index value calculating unit that calculates an index value based on the plural types of information obtained by the information obtaining unit, and a determining unit that predicts a probable future abnormal separation or lack of separation of the recording medium from the recording medium conveyance member based at least on data of a temporal change in the index value calculated by the index value calculating unit.

According to another aspect of the present invention, an image forming apparatus includes an image forming device configured to form an image on a recording medium, a recording medium conveyance member configured to contact and move the recording medium, a separation portion configured to provide normal separation of the recording medium from the recording medium conveyance member, a conveyance path, including the separation portion, through which the recording medium is conveyed by the recording medium conveyance member, and the above-described recording medium conveyance failure occurrence predicting apparatus.

According to yet another aspect of the present invention, a fixing device includes a fixing unit including a first moving element and a second moving element forming a nip part between the first and second moving elements. The fixing unit is configured to fix an image carried on a recording medium at the nip part by heat and pressure. The fixing device further includes a recording medium abnormal track detecting unit configured to detect an abnormal track of a leading edge of the recording medium on a downstream side of the nip part in a surface moving direction of the first and second moving elements.

According to yet another aspect of the present invention, an image forming apparatus includes an image carrier configured to carry an image on the image carrier, a latent image forming device configured to form a latent image on the image carrier, a developing device configured to develop the latent image with toner to form a toner image, a transfer device configured to transfer the toner image to a recording medium one of directly from the image carrier and indirectly through an intermediate transfer element, and the above-described fixing device.

According to yet another aspect of the present invention, a method for predicting an occurrence of a conveyance failure of a recording medium conveyed in a conveyance path in an image forming apparatus, includes detecting an abnormal separation or lack of separation of the recording medium from a recording medium conveyance member; and predicting an occurrence of a conveyance failure of the recording medium based on a detection result obtained in the detecting step.

According to yet another aspect of the present invention, a method for predicting an occurrence of a conveyance failure of a recording medium conveyed in a conveyance path in an image forming apparatus, includes obtaining plural types of information related to a state of the image forming apparatus; calculating an index value based on the plural types of information obtained in the obtaining step; and predicting an occurrence of a conveyance failure of the recording medium based on data of a temporal change in the index value calculated in the calculating step.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a schematic cross section of an image forming apparatus according to an embodiment of the present invention;

FIG. 2 is a schematic enlarged view of a printer unit of the image forming apparatus of FIG. 1;

FIG. 3 is a schematic enlarged view of a part of a tandem image forming device of the image forming apparatus of FIG. 1;

FIG. 4 is a schematic view of a fixing device including a sheet jam occurrence detecting mechanism;

FIG. 5 is a block diagram of a configuration for detecting an occurrence of a sheet jam in the fixing device of FIG. 4;

FIG. 6A is a schematic view of the fixing device of FIG. 4 illustrating a state where a recording sheet is normally conveyed in the fixing device;

FIG. 6B is a schematic view of the fixing device of FIG. 4 illustrating an example of a state where a conveyance failure of a recording sheet occurs in the fixing device;

FIG. 6C is a schematic view of the fixing device of FIG. 4 illustrating another example of a state where a conveyance failure of a recording sheet occurs in the fixing device;

FIG. 7A is a schematic view of a part of the fixing device including a separation pick contact sensor, illustrating a state where a recording sheet is normally separated from a fixing roller in a separation portion;

FIG. 7B is a schematic view of a part of the fixing device including the separation pick contact sensor, illustrating a state where a recording sheet is not normally separated from the fixing roller in the separation portion;

FIG. 8 is a block diagram of a basic configuration for detecting an abnormal separation in the fixing device and for predicting an occurrence of a sheet jam according to the embodiment of the present invention;

FIG. 9A is a schematic view of the fixing device illustrating a state where a recording sheet is separated from the fixing roller by a separation pick;

FIG. 9B is a schematic view of the fixing device illustrating a state where a recording sheet is separated from the fixing roller by own weight and rigidity of the recording sheet before reaching the separation pick even though an abnormal separation occurs in a separation portion;

FIG. 10 is a schematic view of a recording sheet rigidity sensor provided in a conveyance path of a recording sheet according to the embodiment of the present invention;

FIG. 11A is a schematic view of a part of the fixing device including a non-contact-type separation blade and a light sensor, illustrating a state where a recording sheet is normally separated from a fixing roller in a separation portion;

FIG. 11B is a schematic view of a part of the fixing device including the non-contact-type separation blade and the light sensor, illustrating a state where a recording sheet is not normally separated from the fixing roller in the separation portion;

FIG. 12A is a schematic view of a part of the fixing device including a non-contact-type separation blade and a light reflection type sensor, illustrating a state where a recording sheet is normally separated from a fixing roller in a separation portion;

FIG. 12B is a schematic view of a part of the fixing device including the non-contact-type separation blade and the light reflection type sensor, illustrating a state where a recording sheet is not normally separated from the fixing roller in the separation portion;

FIG. 13A is a schematic view of a part of the fixing device including a light transmission type sensor, illustrating a state where a recording sheet is normally separated from a fixing roller in a separation portion;

FIG. 13B is a schematic view of a part of the fixing device including the light transmission type sensor, illustrating a state where a recording sheet is not normally separated from the fixing roller in the separation portion;

FIG. 14 is a block diagram of a basic configuration of a jam occurrence predicting system according to the embodiment of the present invention;

FIG. 15 is a flowchart of a basic operation of the jam occurrence predicting system of FIG. 14;

FIG. 16 is a flowchart showing a procedure for determining a calculation expression of an index value;

FIG. 17 is a table showing a configuration of data of obtained information;

FIG. 18 is a table showing a result of normalization of the data shown in FIG. 17;

FIG. 19 is a flowchart showing a procedure for calculating the index value in step S2 in FIG. 15;

FIG. 20 is a flowchart of a basic operation of the jam occurrence predicting system of FIG. 14 according to an alternative example;

FIG. 21 is a perspective view of a resistance variation element of a thin-film type;

FIG. 22 is a perspective view of another resistance variation element;

FIG. 23 is a perspective view of a humidity sensor;

FIG. 24 is a sectional view of an oscillation sensor;

FIG. 25 is a schematic diagram of a circuit configuration of a toner concentration detecting unit;

FIG. 26 is an assembly diagram of coils in the toner concentration detecting unit of FIG. 25;

FIG. 27 is a schematic diagram of a circuit configuration of a potential measuring system that detects a charging potential;

FIG. 28 is a schematic view of a secondary transfer device that performs a constant-current control in the image forming apparatus of FIG. 1; and

FIG. 29 is a graph showing the change of a transfer voltage applied to a secondary transfer roller according to the passage of a recording sheet.

### DETAILED DESCRIPTION OF THE INVENTION

Examples of embodiments of the present invention are described with reference to the drawings, wherein like reference numerals designate identical or corresponding parts throughout the views.

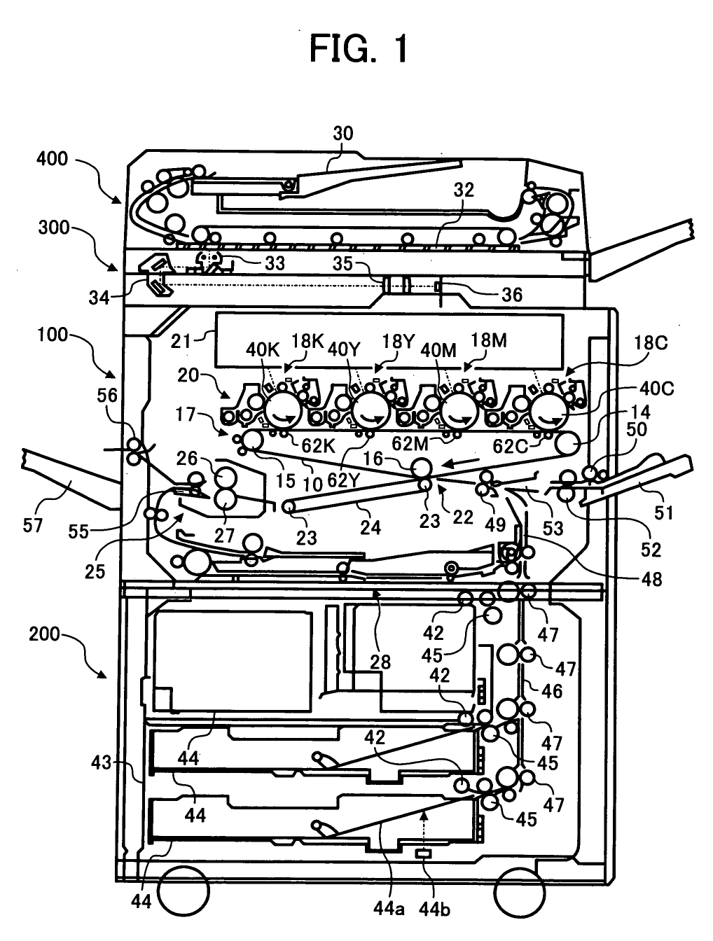

FIG. 1 is a schematic cross section of an electrophotographic image forming apparatus to which the present invention is applied. In this embodiment, the image forming apparatus is a color copying machine. Instead of the color copying machine, the image forming apparatus may be, for example, a printer, a facsimile, a monochrome image forming apparatus, or other similar image forming apparatuses.

The image forming apparatus includes a printer unit 100 acting as a main body of the apparatus, a sheet feeding unit 200, a scanner unit 300, and an automatic document feeder (ADF) 400. The scanner unit 300 is attached to the top of the printer unit 100. The ADF 400 is attached to the top of the scanner unit 300. The image forming apparatus further includes a control unit (not shown) that controls operations of the units and devices in the image forming apparatus. The control unit includes a central processing unit (CPU), a random-access memory (RAM), a read-only memory (ROM), and an input/output interface unit.

The scanner unit 300 reads image information of an original document placed on a contact glass 32 with an image reading sensor 36, and transmits the read image information to the control unit. The control unit controls a laser, LED (not shown), or the like, disposed in an exposure device 21 of the printer unit 100 based on the image information received from the scanner unit 300 to irradiate four drum-shaped photoreceptors 40K, 40Y, 40M, 40C acting as image carriers with a writing laser beam L. By this irradiation, an electrostatic latent image is formed on each of the surfaces of the photoreceptors 40K, 40Y, 40M, 40C. Thus, the exposure device 21 acts as a latent image forming device. Each electrostatic latent image is developed with toner in developing processing, and a toner image of each color is formed. The suffixes K, Y, M, C following the reference numerals correspond to black, yellow, magenta, and cyan images, respectively.

The printer 100 further includes primary transfer rollers 62K, 62Y, 62M, 62C, a secondary transfer device 22, a fixing device 25, a sheet discharging device (not shown), and a toner supply device (not shown).

The sheet feeding unit 200 includes an automatic sheet feeding section disposed beneath the printer unit 100 and a manual sheet feeding section disposed on the side surface of the printer unit 100. The automatic sheet feeding section includes a plurality of sheet feeding cassettes 44 provided in a sheet bank 43, sheet feeding rollers 42 that feed a recording sheet as a recording medium from the sheet feeding cassettes 44, and sheet separation rollers 45 that feed recording sheets one by one to a sheet feeding path 46. The automatic sheet feeding section further includes sheet conveyance rollers 47 that convey a recording sheet to a sheet conveyance path 48 in the printer unit 100. The manual sheet feeding section includes a manual sheet feeding tray 51, a sheet feeding roller 50, and a separation roller 52 that feeds recording sheets set on the manual sheet feeding tray 51 one by one to a sheet feeding path 53.

A pair of registration rollers 49 are disposed near the end of the sheet conveyance path 48 in the printer unit 100. After the registration rollers 49 receive the recording sheet fed from one of the sheet feeding cassettes 44 or the manual sheet feeding tray 51, the registration rollers 49 feed the recording sheet to a secondary transfer nip part formed between an endless intermediate transfer belt 10 acting as an intermediate transfer element and a secondary transfer device 22 at a predetermined timing.

When performing a copying operation in the image forming apparatus, an operator sets an original document on an original document tray 30 in the ADF 400. In another case, the operator opens the ADF 400, sets an original document on the contact glass 32 in the scanner unit 300, and then closes the ADF 400. When the original document is set on the original document tray 30, upon pressing a start switch (not shown), the scanner unit 300 is driven after the original document is conveyed to the contact glass 32. When the original document is set on the contact glass 32, upon pressing a start switch (not shown), the scanner unit 300 is immediately driven. In both the above-described cases, first and second carriages 33 and 34 in the scanner unit 300 are driven. A light source carried on the first carriage 33 irradiates an image surface of the original document with light. The light reflected from the image surface of the original document is directed to the second carriage 34. The light reflected from a mirror carried on the second carriage 34 is imaged on the image reading sensor 36 through an imaging lens 35.

Further, upon pressing a start switch (not shown), a drive motor (not shown) drives one of support rollers 14, 15, and 16 around which the intermediate transfer belt 10 is spanned, thereby rotating the intermediate transfer belt 10. Then, the above-described laser writing processing and developing processing (described below) are performed. Monochrome images such as black, yellow, magenta, and cyan toner images are formed on the photoreceptors 40K, 40Y, 40M, and 40C, respectively, while rotating the photoreceptors. While the intermediate transfer belt 10 rotates, the black, yellow, magenta, and cyan toner images are sequentially and electrostatically transferred from the photoreceptors 40K, 40Y, 40M, and 40C onto the intermediate transfer belt 10 at primary transfer nip parts where the photoreceptors 40K, 40Y, 40M, and 40C contact the intermediate transfer belt 10, and are each superimposed thereon. As a result, a superimposed full-color toner image is formed on the intermediate transfer belt 10.

Further, upon pressing a start switch (not shown), one of the sheet feeding rollers 42 in the sheet feeding unit 200 is driven to feed a recording sheet of a size corresponding to image information out of one of the sheet feeding cassettes 44. Then, the recording sheet is directed to the sheet conveying path 48 provided in the printer unit 100, and then abuts against the nip part between the registration rollers 49. Alternatively, a recording sheet is fed out from the manual sheet feeding tray 51 by rotating the sheet feeding roller 50, and abuts against the nip part between the registration rollers 49. The registration rollers 49 start conveying the recording sheet in synchronism with the rotation of the intermediate transfer belt 10 that carries the full-color toner image thereon, to a secondary transfer nip part between the intermediate transfer belt 10 and a secondary transfer roller 23 of a secondary transfer device 22 provided below the lower run of the intermediate transfer belt 10. In the secondary transfer device 22, an endless secondary transfer belt 24 is spanned around two rollers 23 and pressed against the support roller 16 via the intermediate transfer belt 10. The secondary transfer device 22 transfers the full-color toner image from the intermediate transfer belt 10 to the recording sheet under the influence of a transfer electric field and pressure at the secondary transfer nip part.

The endless secondary transfer belt 24 conveys the recording sheet having the transferred full-color toner image to a fixing device 25. In the fixing device 25, a pressure roller 27 is pressed against a fixing roller 26. The fixing roller 26 and the pressure roller 27 act as a fixing unit. The fixing device 25 fixes the image on the recording sheet under the influence of pressure and heat. Subsequently, a separation pick 55 directs the recording sheet toward sheet discharging rollers 56. The recording sheet is discharged by the sheet discharging rollers 56 and stacked on a sheet discharging tray 57 provided on the side surface of the printer unit 100.

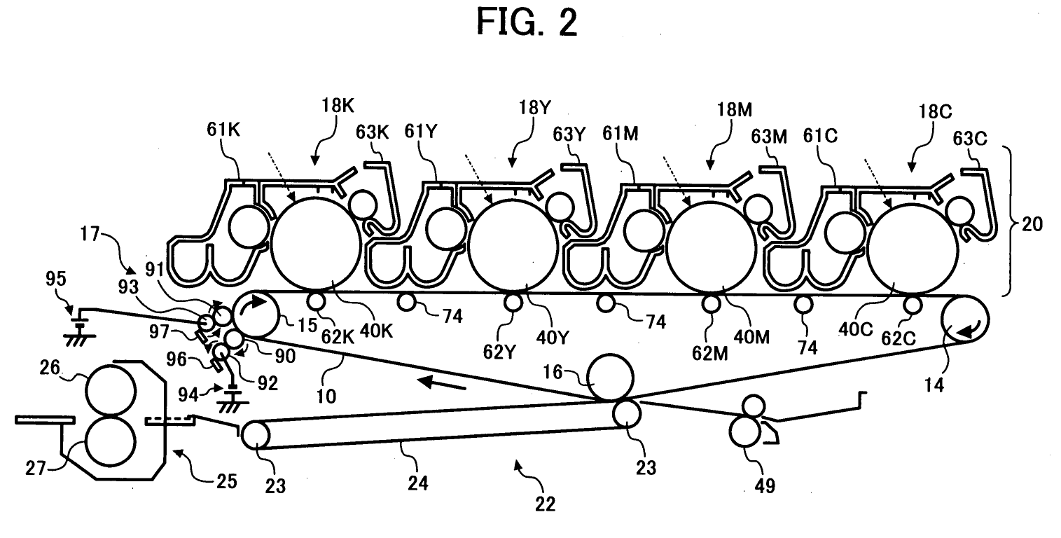

FIG. 2 is a schematic enlarged view of the printer unit 100. The printer unit 100 includes a belt unit, four process units 18K, 18Y, 18M, and 18C that form toner images in each color, respectively, the secondary transfer device 22, a belt cleaning device 17, and the fixing device 25.

In the belt unit, the intermediate transfer belt 10 spanned around the support rollers 14, 15, and 16 moves while contacting the photoreceptors 40K, 40Y, 40M, and 40C. At the primary transfer nip parts where the photoreceptors 40K, 40Y, 40M, and 40C contact the intermediate transfer belt 10, the intermediate transfer belt 10 is pressed toward the photoreceptors 40K, 40Y, 40M, and 40C from the rear surface side thereof by the primary transfer rollers 62K, 62Y, 62M, and 62C. A primary transfer bias is applied to the primary transfer rollers 62K, 62Y, 62M, and 62C by power sources (not shown), respectively. As a result, a primary transfer electric field is formed at the primary transfer nip parts, which causes the toner images formed on the photoreceptors 40K, 40Y, 40M, and 40C to electrostatically transfer to the intermediate transfer belt 10. Conductive rollers 74 contacting the rear surface of the intermediate transfer belt 10 are disposed between each of the primary transfer rollers 62K, 62Y, 62M, and 62C. The conductive rollers 74 prevent the primary transfer bias applied to the primary transfer rollers 62K, 62Y, 62M, and 62C from flowing into the adjacent process unit via a medium resistance base layer on the rear surface side of the intermediate transfer belt 10.

In this embodiment, each photoreceptor (40K, 40Y, 40M, or 40C) and other units are integrally assembled in each of the process units 18K, 18Y, 18M, and 18C. The process units 18K, 18Y, 18M, and 18C are detachably attached to the printer unit 100 for easy maintenance. For example, the black process unit 18K includes the photoreceptor 40K, a developing unit 61K, a photoreceptor cleaning unit 63K, a discharging unit (not shown), and a charging unit (not shown). The developing unit 61K develops an electrostatic latent image formed on the surface of the photoreceptor 40K with black toner and forms a black toner image. The photoreceptor cleaning unit 63K removes residual toner adhered to the surface of the photoreceptor 40K after passing through the primary transfer nip part. The discharging unit discharges the surface of the photoreceptor 40K after the cleaning processing. The charging device uniformly charges the surface of the photoreceptor 40K after the discharging processing to prepare for a next image forming operation. The configurations and operations of the units, such as the photoreceptors 40K, 40Y, 40M, and 40C, the developing units 61K, 61Y, 61M, and 61C, the photoreceptor cleaning units 63K, 63Y, 63M, and 63C of each of the four process units 18K, 18Y, 18M, and 18C are substantially the same except for the color of toner used therein. The image forming apparatus of this embodiment employs a so-called tandem type construction, such as a tandem image forming device 20, in which the four process units 18K, 18Y, 18M, and 18C are arranged side by side above and along the upper and substantially horizontal run of the intermediate transfer belt 10 between the support rollers 14 and 15.

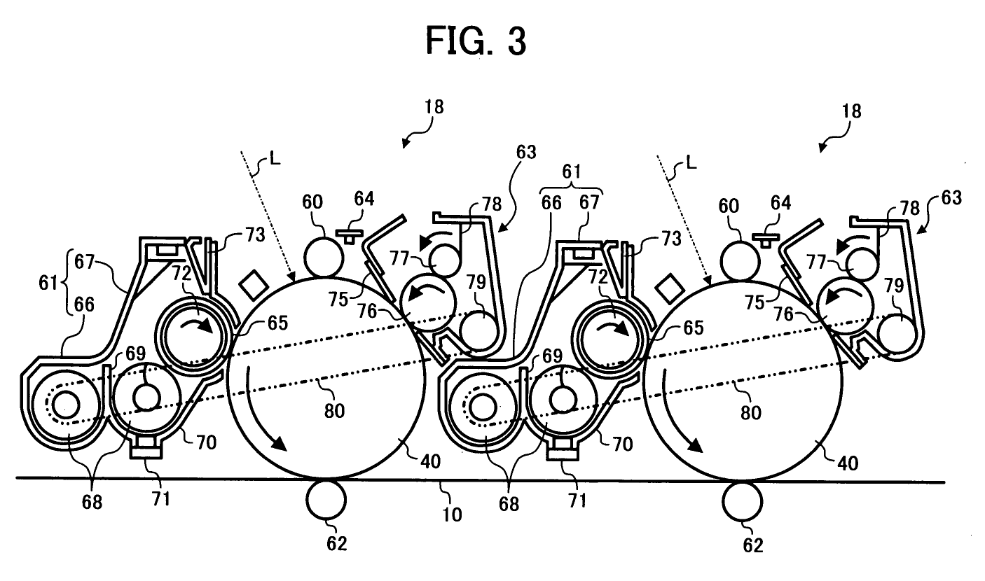

FIG. 3 is a schematic enlarged view of a part of the tandem image forming device 20 including the four process units 18K, 18Y, 18M, and 18C. The configurations and operations of the four process units 18K, 18Y, 18M, and 18C are substantially the same except for the color of toner used therein. Therefore, the suffixes K, Y, M, and C attached to each reference numeral are omitted in FIG. 3. As illustrated in FIG. 3, in each process unit 18, arranged around the photoreceptor 40 are a charging unit 60, the developing unit 61, the primary transfer roller 62, the photoreceptor cleaning unit 63, a discharging unit 64, etc.

A drum-shaped object constructed from a cylinder made of aluminum or the like, which is coated with an organic photosensitive material having a photosensitive property to form a photosensitive layer, is used as the photoreceptor 40. The photoreceptor 40 may be in a shape of an endless belt instead of a drum. The charging unit 60 is constructed from a charging roller that charges the photoreceptor 40 by applying voltages thereto. In this case, the charging roller contacts the photoreceptor 40. In place of the charging roller, the charging unit may be a non-contact type charging unit, such as a scorotron charger.

The developer used in the developing unit 61 is a two-component developer including a mixture of a non-magnetic toner and a magnetic carrier. The developing unit 61 is mainly constructed from a developer agitating section 66 and a developing section 67. The developer agitating section 66 conveys the developer while agitating the developer and supplies the developer to a developing sleeve 65. The developing section 67 transfers the toner in the developer from the developing sleeve 65 to the photoreceptor 40.

The developer agitating section 66 is positioned at a lower level than the developing section 67. The developer agitating section 66 includes two parallel screws 68 partitioned by a partition plate 69 except for both end portions thereof. Further, a toner density sensor 71 is attached to a bottom surface of a case 70 for detecting the toner density of the developer.

The developing sleeve 65 disposed in the developing section 67 faces the photoreceptor 40 through an opening formed in the case 70. Further, a developer regulating member 73 is spaced a predetermined distance, for example about 500 μm, apart from the surface of the developing sleeve 65. The developing sleeve 65 is rotatably provided and formed from a non-magnetic sleeve-shaped member. The developing sleeve 65 includes a magnet roller 72.

In the developing device 61, the two screws 68 circulate the developer in the case 70 while agitating the developer and supply the developer to the developing sleeve 65. The magnet roller 72 magnetically scoops up the developer onto the developing sleeve 65. The scooped-up developer is held on the developing sleeve 65, forming a magnet brush. While the developing sleeve 65 rotates and conveys the magnet brush, the developer regulating member 73 regulates the height of the magnet brush (i.e., the amount of the developer). The excess developer removed by the developer regulating member 73 is returned to the developer agitating section 66.

The toner in the developer transferred from the developing sleeve 65 to the photoreceptor 40 develops a latent image formed on the photoreceptor 40 to form a toner image. After development, the developer remaining on the developing sleeve 65 leaves, at a position where the magnet roller 72 ceases to exert a magnetic force, and returns to the developer agitating section 66. When the density of toner in the developer agitating section 66 decreases due to repeated development, fresh toner is replenished to the developer agitating section 66 based on the detection result of the toner density sensor 71. Instead of the two-component developer, the developing unit 61 may use one component developer including a toner, not a magnetic carrier. In this embodiment, the developing sleeve 65 has a diameter of about 18 mm, and the surface thereof is subjected, for example, to sandblast processing or processing to form a plurality of grooves having a depth of one to several millimeters such that the surface roughness (Rz) is approximately about 10 μm to 30 μm.

In the image forming apparatus, as examples, the linear speed of the photoreceptor 40 is set to about 200 mm/sec, and the linear speed of the developing sleeve 65 is set to about 240 mm/sec. The diameter of the photoreceptor 40 is set to about 50 mm, the thickness thereof is set to about 30 μm, the beam spot diameter of the optical system is set to about 50×60 μm, and the light quantity is set to about 0.47 mW. The charging potential V0 (before exposure) of the photoreceptor 40 is set to about −700V, the post-exposure potential VL is set to about −120V, and the developing bias voltage is set to about −470V. That is, development is performed at a developing potential of about 350V.

The charging amount of the toner on the developing sleeve 65 is preferably within a range of about −10 to −30 μC/g. A developing gap formed between the photoreceptor 40 and the developing sleeve 65 may be set within a range of about 0.4 to 0.8 mm. However, the developing efficiency can be improved by reducing the developing gap.

The photoreceptor cleaning unit 63 includes a cleaning blade 75, made of, for example, polyurethane rubber, contacting the photoreceptor 40 at its edge. A conductive fur brush 76 is rotatably held in contact with the photoreceptor 40. Further, a metallic roller 77 is rotatably provided to apply a bias to the fur brush 76. The leading edge of a scraper 78 is pressed against the metallic roller 77. A screw 79 collects the toner removed from the photoreceptor 40.

Specifically, the fur brush 76, rotating in a direction counter to the photoreceptor 40, removes residual toner from the photoreceptor 40. The metallic roller 77 rotates in a direction counter to the fur brush 76 while applying a bias to the fur brush 76, thereby removing the toner from the fur brush 76. Further, the scraper 78 removes the toner from the metallic roller 77. The toner which gathers in the photoreceptor cleaning unit 63 is moved to one side of the photoreceptor cleaning unit 63 by the screw 79, and is returned to the developing device 61 by a toner recycling device 80 for reuse.

The discharging unit 64 is constructed from a discharging lamp or the like which emits light to remove the surface potential of the photoreceptor 40. After the discharging processing, the surface of the photoreceptor 40 is uniformly charged by the charging unit 60, and then subjected to laser writing processing.

As illustrated in FIG. 2, the secondary transfer device 22 is disposed below the belt unit. In the secondary transfer device 22, the endless secondary transfer belt 24 is spanned around the two rollers 23. One of the two rollers 23 acts as a secondary transfer roller that is charged with a secondary transfer bias by a power source (not shown). The intermediate transfer belt 10 and the secondary transfer belt 24 are sandwiched between the secondary transfer roller 23 and the support roller 16 of the belt unit. Thus, the two belts move in the same direction while contacting each other at the contact portion, thereby forming a secondary transfer nip part. Under the influence of a secondary transfer electric field and nip pressure, the four color superposed toner image on the intermediate transfer belt 10 is secondarily transferred onto a recording sheet that is conveyed from the registration rollers 49 to the secondary transfer nip part, thus forming a full color image. Having passed through the secondary transfer nip part, the recording sheet is separated from the intermediate transfer belt 10 and carried on the surface of the secondary transfer belt 24 to the fixing device 25. The secondary transfer may be performed by a transfer charger instead of the secondary transfer roller.

After passing through the secondary transfer nip part, the surface of the intermediate transfer belt 10 reaches the support position of the support roller 15. Here, the intermediate transfer belt 10 is interposed between the belt cleaning device 17 which contacts the front surface (outer loop surface) of the intermediate transfer belt 10, and the support roller 15 which contacts the rear surface of the intermediate transfer belt 10. The residual toner adhered to the front surface is removed by the belt cleaning device 17. Then, the intermediate transfer belt 10 enters the primary transfer nip parts in succession so that next four color toner images are each superimposed thereon.

The belt cleaning device 17 includes two fur brushes 90 and 91 as cleaning members. The fur brushes 90 and 91 each having a diameter of about 20 mm, are formed from a plurality of acrylic carbon filaments filled into a rotary core at a density of about 6.25 [D/F], 100,000 [1/inch²], and exhibit an electric resistance of approximately 1×10⁷ [Ω]. The fur brushes 90 and 91 mechanically scrape off residual toner on the intermediate transfer belt 10 by rotating the plurality of filaments in a direction counter to the filling direction of the filaments while contacting the intermediate transfer belt 10. The scraped residual toner is electrostatically attracted and collected by applying a cleaning bias from a power source (not shown).

Metallic rollers 92 and 93 rotate in a forward direction or reverse direction to the fur brushes 90 and 91 while contacting the fur brushes 90 and 91, respectively. A negative voltage is applied to the metallic roller 92 positioned on the upstream side in the direction of rotation of the intermediate transfer belt 10 by a power source 94. Further, a positive voltage is applied to the metallic roller 93 positioned on the downstream side by a power source 95. The leading edges of blades 96 and 97 contact the metallic rollers 92 and 93, respectively. In this configuration, while the intermediate transfer belt 10 moves in the direction indicated by an arrow in FIG. 2, the fur brush 90 located on the upstream side cleans the surface of the intermediate transfer belt 10. At this time, for example, if −700V is applied to the metallic roller 92 and −400V is applied to the fur brush 90, first the positive polarity toner on the intermediate transfer belt 10 is electrostatically transferred to the fur brush 90. Then, the toner, which has been transferred to the fur brush 90, is transferred to the metallic roller 92 from the fur brush 90 due to the potential difference, and is scraped off by the blade 96.

A lot of toner is left on the intermediate transfer belt 10 even after the fur brush 90 has removed the toner from the intermediate transfer belt 10. This toner is charged with a negative polarity by the negative bias applied to the fur brush 90. This charging is assumed to be performed by charge injection or discharge. Then, the fur brush 91 removes the remaining toner on the intermediate transfer belt 10 by applying a positive bias thereto. The removed toner is transferred to the metallic roller 93 from the fur brush 91 by the potential difference, scrapped off by the blade 97, and collected in a tank (not shown).

Although most of the toner is removed from the surface of the intermediate transfer belt 10 by the cleaning of the fur brush 91, a little amount of toner still remains. The remaining toner on the intermediate transfer belt 10 is charged with a positive polarity by the positive bias applied to the fur brush 91. This toner is transferred toward the photoreceptors 40K, 40Y, 40M, and 40C by a transfer electric field applied at the primary transfer position, and collected by the photoreceptor cleaning device 63.

Although the registration rollers 49 are often grounded, a bias may be applied to the registration rollers 49 to remove paper powders of the recording sheet. A conductive rubber roller, for example, is used to apply the bias. The roller may have a diameter of about 18 mm, and be covered with conductive NBR rubber having a thickness of about 1 mm. The electric resistance is equivalent to the volume resistivity of the rubber material, approximately 10×10⁹ [Ω×cm]. A voltage of about −800V is applied to the side (front side) on which toner is transferred. A voltage of about +200V is applied to the rear surface side of the sheet.

Generally, in the intermediate transfer system, paper powders cannot easily move to the photoreceptors. For this reason, the intermediate transfer system may be grounded without taking the transfer of paper powders into consideration greatly. The voltage is generally applied as a DC bias, but may be applied as an AC voltage containing a DC offset component to charge the recording sheet more evenly. Thus, the sheet surface having passed through the registration rollers 49 applied with a bias in this manner is charged slightly to the negative side. Accordingly, during transfer from the intermediate transfer belt 10 to the recording sheet, the transfer conditions may vary from those when no voltage is applied to the registration rollers 49.

A recording sheet reversing device 28 is provided below the secondary transfer device 22 and the fixing device 25 to reverse a recording sheet for forming images on dual sides of the recording sheet (i.e., in a dual side copy mode). The recording sheet reversing device 28 extends in parallel to the tandem image forming device 20.

In the above-described image forming apparatus, toner images of different colors, which have been formed on the photoreceptors 40K, 40Y, 40M, 40C, are transferred to the intermediate transfer belt 10 while being superimposed on one another by the respective primary transfer rollers 62K, 62Y, 62M, 62C. Subsequently, a superimposed color image is transferred from the intermediate transfer belt 10 to a recording sheet by the secondary transfer device 22. Alternatively, color toner images formed on the photoreceptors 40K, 40Y, 40M, 40C may be directly transferred to a recording sheet while being superimposed on one another.

Before describing a configuration for predicting an occurrence of a sheet jam in the fixing device 25, a description is made of an occurrence of a sheet jam in the fixing device 25 and a sheet jam occurrence detecting mechanism.

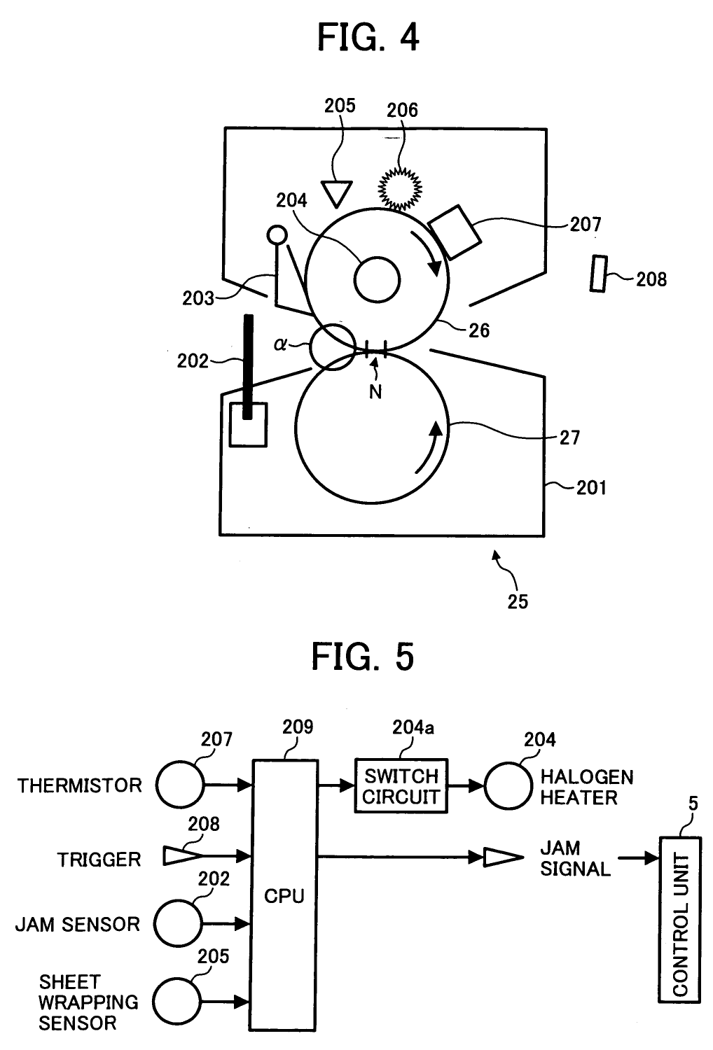

FIG. 4 is a schematic view of the fixing device 25 including a sheet jam occurrence detecting mechanism. In FIG. 4, a reference character “a” indicates a separation portion located on a downstream side of a nip part “N” formed between the fixing roller 26 and the pressure roller 27 in a surface moving direction of the fixing roller 26 and the pressure roller 27. In the separation portion “α”, a recording sheet P is separated from the fixing roller 26 and the pressure roller 27 after passing through the nip part “N”. A separation pick 203 acting as a contact-type recording medium separating member contacts the fixing roller 26 to separate the recording sheet P, which has not been separated from the fixing roller 26 in the separation portion “α” and has attached onto the fixing roller 26, from the fixing roller 26. The separation pick 203 is formed from a plate-shaped thin pick having a thickness of about 1 mm and a width of about 1 to 2 mm. The plate-shaped thin separation pick 203 is brought into contact with the circumferential surface of the fixing roller 26 by a biasing member, such as a spring, with an appropriate pressing force. For example, three to five pieces of the separation picks 203 are disposed at predetermined intervals along the axial direction of the fixing roller 26. The fixing roller 26 is a member extending in its axis direction, and has deflections in the axial direction. Because it is difficult to contact a separation pick in a shape that can follow such deflections, three to five pieces of the plate-shaped thin separation picks 203 are brought into contact with the fixing roller 26 with an appropriate pressing force at predetermined intervals along the axial direction of the fixing roller 26.

Further, a sheet wrapping sensor 205 is disposed on a downstream side of the separation pick 203 in the surface moving direction of the fixing roller 26 to detect that the recording sheet P is not separated from the fixing roller 26 by the separation pick 203 and is wrapped around a part of the circumferential surface of the fixing roller 26. Moreover, a lubricant applying roller 206 and a thermistor 207 are disposed around the fixing roller 26. The lubricant applying roller 206 applies a lubricant to the fixing roller 26 to prevent toner from being adhered onto the fixing roller 26. The thermistor 207 detects a temperature of the fixing roller 26.

Further, a trigger 208 is disposed on an upstream side of the nip part “N” in a recording sheet conveying direction to detect the entry of the recording sheet P into the fixing device 25. Moreover, a jam sensor 202 is disposed near the outlet of the fixing device 25 located on a downstream side of the nip part “N” in the recording sheet conveying direction. The jam sensor 202 includes a lever that falls down when the recording sheet P normally passes through the fixing device 25.

The fixing roller 26 includes a halogen heater 204. In the fixing device 25, the fixing roller 26 and the pressure roller 27 are configured to rotate and contact with each other with a high pressing force. The recording sheet P is directed to the nip part “N” formed between the fixing roller 26 and the pressure roller 27, and a toner image carried on the recording sheet P is fused and pressed under the influence of heat and pressure of the fixing roller 26 and the pressure roller 27.

As compared to a non-image portion of the recording sheet P, a toner image portion is protruded from the surface of the recording sheet P due to a height of the toner image. Generally, an image quality of a fixed toner image is improved by using a fixing roller having a flexible surface that can follow concave (non-image) and convex (toner image) portions of the recording sheet P. For this reason, a silicone rubber is often used as a material of the fixing roller, which makes a flexible surface having good durability against a high temperature. Because fused toner tends to adhere to the surface of the fixing roller 26 made of a silicone rubber and thereby the recording sheet P having a toner image tends to be wrapped around a part of the circumferential surface of the fixing roller 26, a lubricant is applied to the surface of the fixing roller 26 in advance to prevent such toner adhesion and sheet wrapping. In the fixing device 25 of FIG. 4, the fused toner is prevented from adhering to the surface of the fixing roller 26 by applying silicone oil to the surface of the fixing roller 26 by the lubricant applying roller 206 and by adding a lubricative material such as carnauba wax in toner, for example.

Examples of a cause of an occurrence of a sheet jam in the fixing device 25 under the condition that an adhesion force between the recording sheet P and the fixing roller 26 changes and the recording sheet P is wrapped around a part of the circumferential surface of the fixing roller 26, may be considered as follows.

Generally, an inorganic compound such as calcium carbonate is added in the recording sheet P. The fine particles of the inorganic compound have a high hardness and a fracturing shape. Therefore, the fine particles may cut into the surface of the fixing roller 26 and stay there. As a result, the surface of the fixing roller 26 may get rough, so that the toner may adhere to the surface of the fixing roller 26 even though the lubricant applying roller 206 applies a lubricant material to the fixing roller 26 and the recording sheet P may wrap around a part of the circumferential surface of the fixing roller 26. Thus, a sheet jam may occur.

Further, a sheet jam may be caused due to various faults. For example, the temperature of the halogen heater 204 may not be adequately controlled due to the fault of the thermistor 207. Further, a lubricant may not be adequately applied to the surface of the fixing roller 26 due to the stained surface of the lubricant applying roller 206. Because a sheet jam may be caused due to various faults, there is a limitation to solve a problem by enhancing a reliability of each individual part or component and by detecting each fault, in view of cost.

Once a sheet jam occurs, an image forming apparatus needs an emergency halt, and a user needs to remove the jammed recording sheet P and all the recording sheets P stopped and stayed in the apparatus due to the emergency halt. Thus, the sheet jam causes significant decrease of productivity and troublesome jammed sheet removing operations.

Differently from a sheet jam caused by a misoperation of a user, a sheet jam caused by faults or an end of useful life of a component is likely to occur again even though a jammed sheet is removed. In this case, the replacement of the fixing roller 26, for example, and the repair of the faults are necessary.

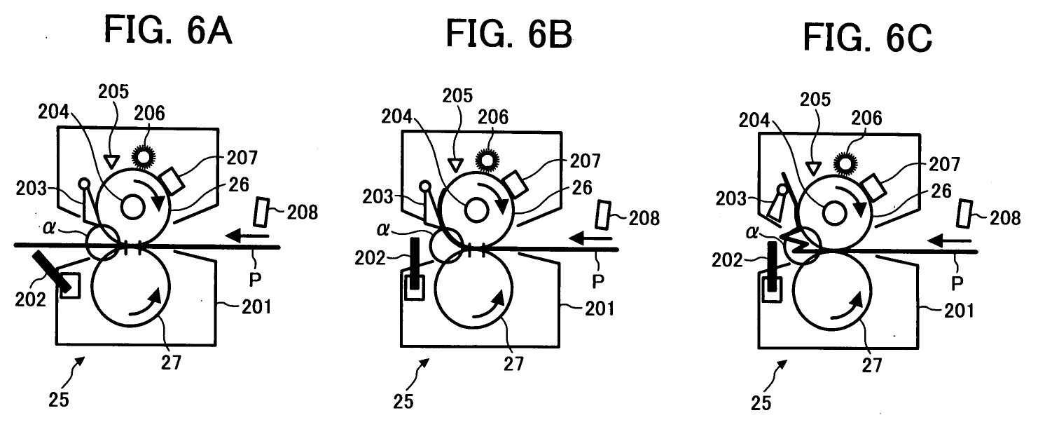

FIG. 5 is a block diagram of a configuration for detecting an occurrence of a sheet jam in the fixing device 25. The detection of an occurrence of a sheet jam is described with reference to FIG. 5 and FIGS. 6A through 6C. FIG. 6A is a schematic view of the fixing device 25 illustrating a state where the recording sheet P is normally conveyed in the fixing device 25. First, the trigger 208 detects the entry of the recording sheet P into the fixing device 25, and outputs a trigger signal to a central processing unit (CPU) 209. So long as the recording sheet P is conveyed normally in the fixing device 25, the recording sheet P gets down the lever of the jam sensor 202 within a predetermined time period from the output of the trigger signal from the trigger 208, and the jam sensor 202 outputs a sheet passage signal to the CPU 209. If the CPU 209 receives the sheet passage signal from the jam sensor 202 within a predetermined time period from the receipt of the trigger signal from the trigger 208, the CPU 209 determines that the recording sheet P is conveyed normally in the fixing device 25.

FIG. 6B is a schematic view of the fixing device 25 illustrating an example of a state where a conveyance failure of the recording sheet P occurs in the fixing device 25. Specifically, the leading edge of the recording sheet P reaches a position near the sheet wrapping sensor 205 without separating from the fixing roller 26 by using the rigidity of the recording sheet P in the separation portion “α” and without separating from the fixing roller 26 by the action of the separation pick 203. When the sheet wrapping sensor 205 detects the entry of the recording sheet P, the sheet wrapping sensor 205 outputs a sheet detection signal to the CPU 209, and then the CPU 209 outputs a jam signal to a control unit 5. Upon receiving the jam signal, the control unit 5 stops an operation of each unit in the printer unit 100, and notifies a user of an occurrence of a sheet jam via a display unit (not shown) or an external apparatus (not shown), such as a personal computer, via communication lines.

FIG. 6C is a schematic view of the fixing device 25 illustrating another example of a state where a conveyance failure of the recording sheet P occurs in the fixing device 25. Specifically, the recording sheet P passes through a contact portion of the separation pick 203 and the fixing roller 26 without separating from the fixing roller 26 in the separation portion “α”. Subsequently, the recording sheet P separates from the fixing roller 26 such that the recording sheet P raises the separation pick 203, and is stacked in the fixing device 25 in a complicated state without reaching the sheet wrapping sensor 205. In this case, even though the sheet wrapping sensor 205 does not output a sheet detection signal to the CPU 209, the CPU 209 determines that a sheet jam occurs in the fixing device 25 because the CPU 209 does not receive a sheet passage signal from the jam sensor 202 after a predetermined time has elapsed since the CPU 209 receives the trigger signal from the trigger 208. Then, the CPU 209 outputs a jam signal to the control unit 5. Upon receiving the jam signal, the control unit 5 stops an operation of each unit in the printer unit 100, and notifies a user of an occurrence of a sheet jam via a display unit or an external apparatus.

When a sheet jam occurs in a condition that the recording sheet P is wrapped around the part of the fixing roller 26, the recording sheet P remains in a condition that the recording sheet P carrying an unfixed toner image contacts the fixing roller 26 heated to about 170 degrees centigrade. Ignition may not occur, but an abnormal odor may be produced, causing a user to have feelings of anxiety. Further, the recording sheet P stays at the nip part “N” while being pinched between the fixing roller 26 heated to a high temperature and the pressure roller 27 having a great pressing force. Therefore, it takes time and effort for removing the jammed recording sheet P from the nip part “N” due to the necessity of a natural cooling time and an operation force, causing a great time loss for the user.

To detect an occurrence of a sheet jam in a short period of time, the CPU 209 outputs a jam signal to the control unit 5 based on the detection signals output from the trigger 208, the jam sensor 202, and the sheet wrapping sensor 205 as described with reference to FIGS. 6A through 6C. These sensors detect an occurrence of a sheet jam, but cannot detect a fault condition causing a reoccurrence of a sheet jam in the fixing device 25.

The present inventors found that before a sheet separation failure occurs in the separation portion “α” causing a sheet jam, a separation position where the recording sheet P is separated from the fixing roller 26 shifts toward the downstream side of the nip part “N” in the surface moving direction of the fixing roller 26 due to the decrease of separability between the recording sheet P and the fixing roller 26. In addition, the present inventors found that the track of the leading edge of the recording sheet P which has passed through the nip part “N”, changes in the separation portion “α”, and the recording sheet P passes through an irregular area where the recording sheet P does not pass in a normal state. By detecting the entry of the recording sheet P into such an irregular area, an abnormal track of the recording sheet P may be detected, and an occurrence of a conveyance failure due to a separation failure between the recording sheet P and the fixing roller 26 may be predicted.

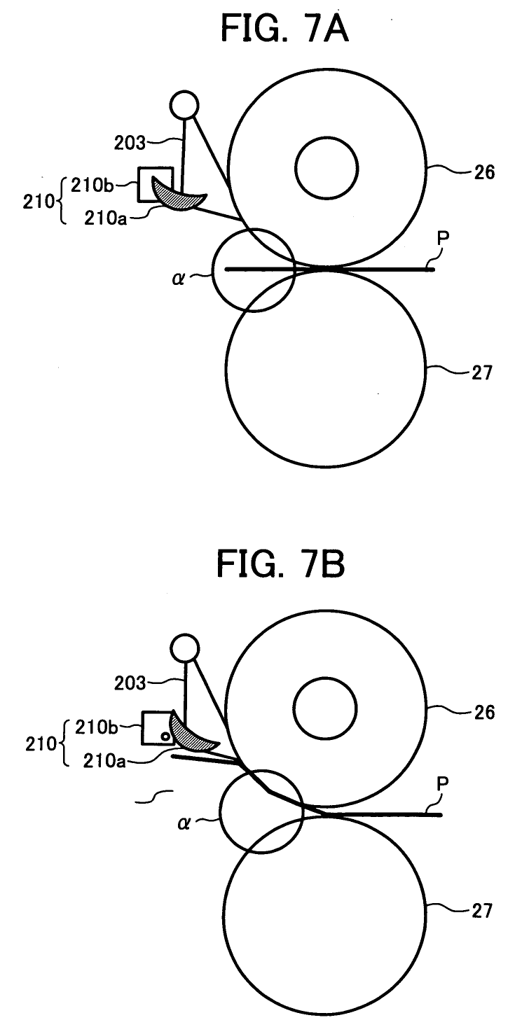

FIG. 7A is a schematic view of a part of the fixing device 25 illustrating a state where the recording sheet P normally passes through the nip part “N” and is separated from the fixing roller 26 in the separation portion “α”. FIG. 7B is a schematic view of a part of the fixing device 25 illustrating a state where the recording sheet P is not normally separated from the fixing roller 26 in the separation portion “α”.

In the fixing device 25 of FIGS. 7A and 7B, a separation pick contact sensor 210 acting as a contact-type separation detecting member is disposed to detect the contact of the recording sheet P with the separation pick 203. Specifically, the separation pick contact sensor 210 detects that the recording sheet P makes a track different from a normal track. The separation pick contact sensor 210 includes a recording sheet contact lever 210a and a lever detecting portion 210b. The recording sheet contact lever 210a rotates in a clockwise direction in FIGS. 7A and 7B when the recording sheet P contacts the lever 210a. The lever detecting portion 210b detects the rotation of the lever 210a.

When the recording sheet P is normally conveyed in the fixing device 25, the separation pick 203 does not act and the recording sheet P is separated from the fixing roller 26 in the separation portion “α” due to the rigidity of the recording sheet P and the deformation of the fixing roller 26 at the nip part “N”. In this normal state, the recording sheet P does not contact the separation pick 203 and the recording sheet contact lever 210a.

In an abnormal state shown in FIG. 7B, the leading edge portion of the recording sheet P is separated from the fixing roller 26 by the separation pick 203, and is conveyed toward the downstream side in the sheet conveying direction. The recording sheet P, which has been removed from the fixing roller 26 by the separation pick 203, moves along the separation pick 203 toward the downstream side in the sheet conveying direction. At this time, the recording sheet P contacts the recording sheet contact lever 210a and rotates the recording sheet contact lever 210a in the clockwise direction in FIG. 7B. The rotation of the recording sheet contact lever 210a is detected by the lever detecting portion 210b. As a result, it is detected that the recording sheet P made such an abnormal track as to contact the separation pick 203. A photodetector configured to optically detect the shift of the recording sheet contact lever 210a may be used as the lever detecting portion 210b.

As described above, by detecting such an abnormal track that the recording sheet P contacts the recording sheet contact lever 210a, an occurrence of an abnormal separation of the recording sheet P can be detected, in which the position where the recording sheet P is separated from the fixing roller 26 in the separation portion “α” is shifted toward the downstream side in the surface moving direction of the fixing roller 26.

The maintenance, such as, for example, repair or replacement of parts or components, are not always required in the state illustrated in FIG. 7B. For example, when a toner image is formed on the leading edge portion of the recording sheet P, when the recording sheet P is deformed, when the recording sheet P is a thin sheet having a low rigidity, and when these conditions are combined, the separation position where the recording sheet P is separated from the fixing roller 26 may be shifted toward the downstream side in the surface moving direction of the fixing roller 26. If an occurrence of a conveyance failure is predicted every time this case is detected as an abnormal separation, a maintenance request, such as a service person call, may be performed even though it is not a condition requiring repair or replacement of parts or components.

As described above, the action of the separation pick 203 is also performed even if maintenance is not required, and is affected by use conditions. The accuracy of the prediction of an occurrence of a sheet jam is enhanced by taking not only the detection result of an abnormal separation but also other information, such as action number or rate of the separation pick 203, into consideration.

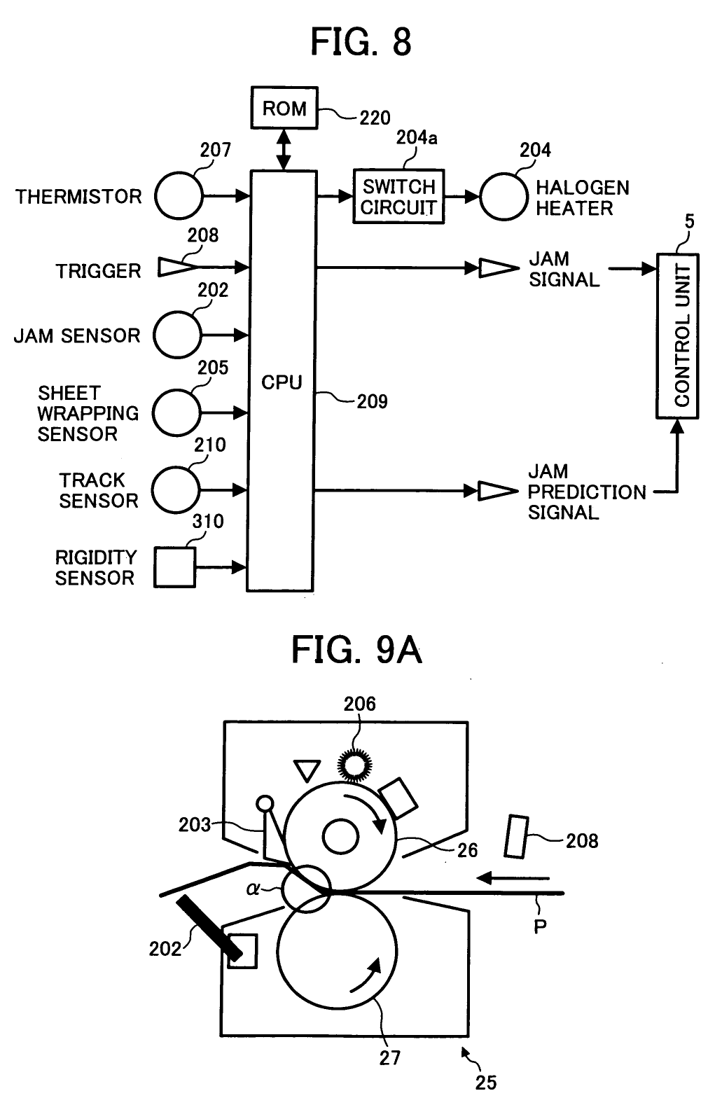

FIG. 8 is a block diagram of a basic configuration for detecting an abnormal separation in the fixing device 25 and for predicting an occurrence of a sheet jam according to the embodiment of the present invention. That is, the configuration illustrated in FIG. 8 except the control unit 5 configures a recording medium conveyance failure occurrence predicting apparatus according to the embodiment of the present invention. The configuration of FIG. 8 is similar to the configuration of FIG. 5 except that the following items: 1) the detection result of the lever detecting portion 210b of the separation pick contact sensor 210 is input to the CPU 209; 2) the detection result of a recording sheet rigidity sensor 310 (described below) is input to the CPU 209; 3) a read-only memory (ROM) 220 for storing the information subjected to the processing in the CPU 209 is disposed; and 4) a jam prediction signal is output from the CPU 209 to the control unit 5.

A jam occurrence prediction is described with reference to FIGS. 7A and 7B and FIG. 8. When the separation pick contact sensor 210 detects an abnormal separation of the recording sheet P during the recording sheet P is conveyed in the fixing device 25, the detection result of the rigidity of the recording sheet P which has caused the abnormal separation, an abnormality occurrence number, and a sheet conveyance number are stored in a ROM 220 acting as a storage unit. When an abnormal separation occurs during a conveyance of the recording sheet P having a high rigidity, and when an abnormality occurrence number relative to a sheet conveyance number (i.e., an occurrence rate) is great and an abnormality frequently occurs even though the recording sheet P having not so high rigidity is used, the CPU 209 outputs a jam prediction signal to the control unit 5, indicating that the possibility of the jam occurrence is high. Thus, the CPU 209 acts as a determining unit that predicts an occurrence of a sheet jam in the fixing device 25 based on detection results of recording sheet abnormal separation detecting units. Upon receiving the jam prediction signal, the control unit 5 notifies a user of the high possibility of an occurrence of a sheet jam and the necessity of maintenance via a display unit or an external apparatus.

The accuracy of the prediction of an occurrence of a sheet jam is enhanced by causing the CPU 209 to output a jam prediction signal taking the number or rate of an occurrence of an abnormal separation and the rigidity of the recording sheet P that has caused the abnormal separation into consideration.

Further, image information of an unfixed image carried on the recording sheet P may be taken into consideration to enhance the accuracy of the prediction of an occurrence of a sheet jam. An unfixed toner image may be considered as a cause of a separation failure between the recording sheet P and the fixing roller 26. Specifically, an unfixed toner image heated and fused by the fixing roller 26 typically causes the recording sheet P to adhere to the fixing roller 26 depending the viscosity of the toner. If a ratio of an image area on the recording sheet P is high, the viscosity of toner increases, and the recording sheet P tends to adhere to the fixing roller 26. As a result, a sheet separation failure tends to occur. Especially, if a ratio of an image area on the leading edge portion of the recording sheet P is high, the recording sheet P tends to adhere to the fixing roller 26 irrespective of the rigidity of the recording sheet P. For this reason, if the recording sheet P, which has a high ratio of an image area on the leading edge portion of the recording sheet P and does not have a high rigidity, is not separated adequately from the fixing roller 26 and makes an abnormal track, it is a normal state in some senses. In contrast, if a separation failure of the recording sheet P occurs even though a ratio of an image area of the recording sheet P is not so high, the recording sheet P may adhere to the fixing roller 26 under the condition that the viscosity of toner is small. This condition is assumed as an abnormal state. If an abnormal separation occurs frequently, information of an image on the recording sheet P needs to be taken into consideration as data for predicting an occurrence of a sheet jam even though the recording sheet P has a low rigidity.

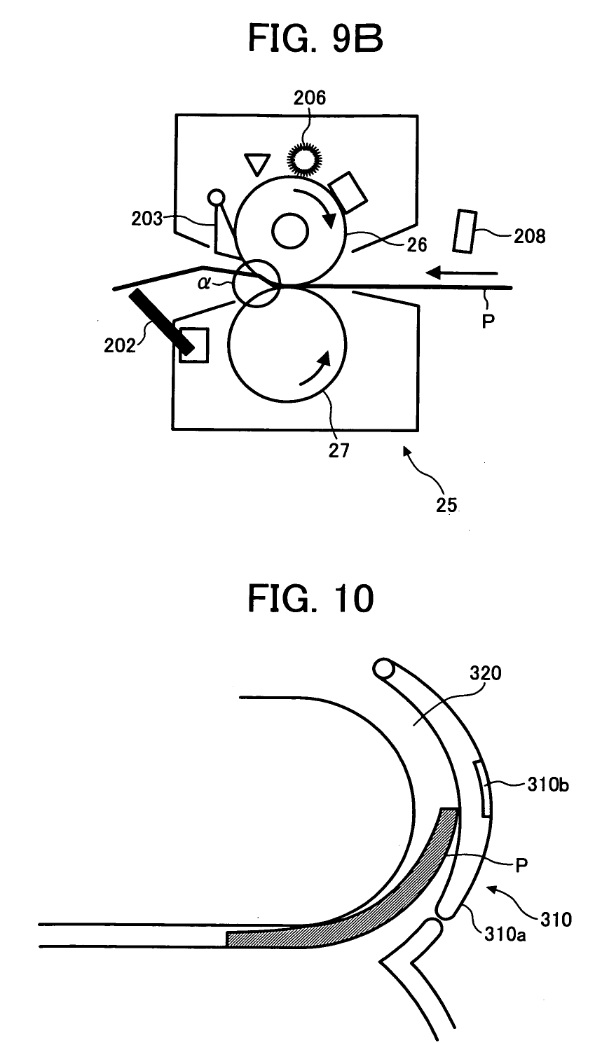

In the configuration of the fixing device 25 of FIGS. 7A and 7B using the separation pick contact sensor 210, an abnormal separation is not detected unless the recording sheet P contacts the separation pick 203. FIGS. 9A and 9B illustrate two types of abnormal separations. FIG. 9A illustrates a state where the recording sheet P is separated from the fixing roller 26 by the separation pick 203. FIG. 9B illustrates a state where the recording sheet P is separated from the fixing roller 26 by the own weight and rigidity of the recording sheet P before reaching the separation pick 203 even though an abnormal separation occurs in the separation portion “α”. The separation pick contact sensor 210 can detect an abnormal separation occurred in FIG. 9A, but cannot detect an abnormal separation occurred in FIG. 9B. If the recording sheet P conveyed in the fixing device 25 of FIG. 9B has a low rigidity and has a tendency to be adhered to the fixing roller 26, it is not a significant problem unless an abnormal separation is detected. However, if the recording sheet P conveyed in the fixing device 25 of FIG. 9B has a high rigidity, a low ratio of an image area, and doesn't have a tendency to be adhered to the fixing roller 26, it is assumed as an abnormal state. In this case, the non-detection of the abnormal separation is a problem.

To detect an abnormal separation in FIG. 9B, the trigger signal output from the trigger 208 and the sheet passage signal output from the jam sensor 202 are used as information for predicting an occurrence of a sheet jam. In the state of FIG. 9A, an interval between the trigger signal and the sheet passage signal becomes a little greater than that in a normal state because the track of the recording sheet P is longer than a normal track thereof. Even in the state of FIG. 9B, an interval between the trigger signal and the sheet passage signal becomes a slightly greater than that in a normal state. The abnormal separation in FIG. 9B can be detected by detecting the increased interval between the trigger signal and the sheet passage signal with the CPU 209.

However, the interval between the trigger signal and the sheet passage signal may be changed due to conveyance failures such as a decrease of a conveyance speed due to wear of the conveyance rollers, other than the separation failure. For this reason, it is not preferable to predict an occurrence of a sheet jam based on only the interval change. Therefore, an occurrence of a sheet jam need to be predicted in view of the detection result of the separation pick contact sensor 210 obtained when the recording sheet P has a low rigidity.

Next, the recording sheet rigidity sensor 310 acting as a recording medium rigidity detecting unit is described.

By providing a strain gauge at a portion of a guide member where the conveying direction of the recording sheet P greatly changes, like a portion around the sheet feeding path 53, the rigidity of the recording sheet P that hits the guide member can be detected.

FIG. 10 is a schematic view of the recording sheet rigidity sensor 310 provided in a conveyance path 320 of the recording sheet P according to the embodiment of the present invention. In FIG. 10, the recording sheet rigidity sensor 310 includes a guide plate 310a and a strain gauge 310b. The guide plate 310a is formed from a material that prevents the guide plate 310a from being deformed even if the recording sheet P repeatedly hits against the guide plate 310a. The upper portion of the guide plate 310a is fixed, and the lower portion of the guide plate 310a is configured to move freely. The strain gauge 310b is disposed on the outer side of the guide plate 310a.

The recording sheet P conveyed in the conveyance path 320 hits against the guide plate 310a and is then guided along the conveyance path 320. The guide plate 310a hit by the recording sheet P slightly deforms such that the guide plate 310a bends outward. When the guide plate 310a bends outward, the length of a resistive element of the strain gauge 310b slightly decreases. As the length of the resistive element decreases, the resistance value of the resistive element decreases, so that a current flows easily. The strain gauge 310b detects the deformation of the guide plate 310a by the slight change of the current.

The data of deformation of the guide plate 310a relative to the rigidity of the recording sheet P is input to a storage unit (not shown) in advance. The rigidity of the recording sheet P is detected based on the change amount of the current detected by the strain gauge 310b and the data of deformation of the guide plate 310a stored in the storage unit. By disposing the recording sheet rigidity sensor 310 and by predicting an occurrence of a sheet jam in view of the rigidity of the recording sheet P acting as one of the main factors in the tendency to be adhered to the fixing roller 26, the accuracy of the prediction of an occurrence of a sheet jam can be enhanced.

As an alternative to the data of rigidity of the recording sheet P, data of thickness of the recording sheet P may be used. In the above-described embodiment, an accurate data value of the rigidity of the recording sheet P is not required, but the detection of how easily the recording sheet P bends is required. Therefore, a high accuracy of the detection result of the rigidity of the recording sheet P is not required. Because the rigidity of the recording sheet P greatly depends on the thickness of the recording sheet P, it is not a big problem if the data of thickness of the recording sheet P is used instead of the data of rigidity thereof.

As a non-limiting example of a recording medium thickness detecting unit that detects a thickness of the recording sheet P, a sensor that detects a gap between the pair of conveyance rollers of the recording sheet P may be used. The pair of conveyance rollers may be any conveyance roller pair disposed in the sheet feeding path 46, the sheet conveyance path 48, or any other sheet paths in the image forming apparatus of FIG. 1. Therefore, the detection place of this sensor is not limited as compared to the recording sheet rigidity sensor 310. However, because the sensor detects the thickness of the recording sheet P sheet by sheet, an error may occur.

As another non-limiting example, a sheet amount sensor 44b may be used as the recording medium thickness detecting unit. As illustrated in FIG. 1, the sheet amount sensor 44b is disposed below a bottom plate 44a provided in the sheet feeding cassette 44. The bottom plate 44a is biased by a biasing device (not shown), such as, a plate spring, such that the leading edge side in the sheet feeding direction of the recording sheets P (illustration is omitted in FIG. 1) loaded on the bottom plate 44a rotates upward as the number of the recording sheets P fed out from the sheet feeding cassette 44 increases. The sheet amount sensor 44b is configured to emit a laser light toward the bottom plate 44a to detect a distance therebetween. For example, every time after twenty pieces of the recording sheets P are fed out from the sheet feeding cassette 44, the sheet amount sensor 44b emits a laser light toward the bottom plate 44a to detect the distance therebetween. The increased distance between the sheet amount sensor 44b and the bottom plate 44a corresponds to the thickness of the twenty pieces of the recording sheets P. So, the thickness of one piece of the recording sheet P can be detected by dividing the value of the increased distance by twenty. As an alternative example, the sheet amount sensor 44b may be disposed above the recording sheets P loaded on the bottom plate 44a to detect a distance between the sheet amount sensor 44b and the uppermost sheet of the recording sheets P loaded on the bottom plate 44a.

The above-described sheet amount sensor 44b is generally used as a recording sheet remaining amount sensor in the sheet feeding unit 200 of the image forming apparatus to detect a remaining amount of the recording sheets P in each sheet feeding cassette 44. Therefore, an additional sensor need not be provided in the sheet feeding unit 200 as the recording medium thickness detecting unit, thereby reducing the number of parts and the cost of the apparatus.

The above-describe detection data such as the rigidity, and thickness of the recording sheet P, is not real-time data. In predicting an occurrence of a sheet jam, the real-time data may not be necessarily required. The determination accuracy may be increased by determining based on accumulated non-real time data (data obtained in the past).

The cause of an occurrence of a sheet jam in the fixing device 25 is not only the deterioration of the fixing roller 26 and a toner adhesion to the fixing roller 26 but also problems caused by other members. Hereafter, an example of the problem caused by the thermistor 207 is described.

In the recording medium conveyance failure occurrence predicting apparatus of FIG. 8, information of the temperature of the fixing roller 26 detected by the thermistor 207 is also input to the CPU 209. The CPU 209 determines whether the temperature of the fixing roller 26 is a desired value. If necessary, the CPU 209 controls a switch circuit 204a of the halogen heater 204 included in the fixing roller 206 such that the fixing temperature of the fixing roller 206 becomes a desired value. For example, if a foreign substance, such as toner, is adhered to the thermistor 207, the thermistor 207 may detect the temperature of the fixing roller 26 as being lower than an actual temperature. By detecting so, the CPU 209 controls the switch circuit 204a of the halogen heater 204 to heat the fixing roller 26, so that the actual temperature of the fixing roller 26 becomes higher than a desired value. If the temperature of the fixing roller 26 becomes higher than necessary, toner of a toner image carried on the recording sheet P may be significantly fused, and the recording sheet P tends to be adhered to the fixing roller 26. As a result, an abnormal separation is likely to occur.

In this condition, the response of the thermistor 207 to a temperature change delays than usual due to the attachment of the foreign substance to the thermistor 207. By detecting the delay of the response of the thermistor 207 to the temperature change, the thermistor 207 is determined as the cause of an occurrence of a sheet jam in the fixing device 25, and an occurrence of a sheet jam can be predicted.

In the fixing device 25 illustrated in FIGS. 7A and 7B, the separation pick contact sensor 210 acting as an abnormal track detecting unit or a contact-type separation detecting member is disposed to detect the contact of the recording sheet P with the separation pick 203. In this configuration, an abnormal track made by the recording sheet P after passing through the nip part “N” can be detected. By detecting an abnormal track of the recording sheet P, an occurrence of an abnormal separation of the recording sheet P can be detected, in which the position where the recording sheet P is separated from the fixing roller 26 in the separation portion “α” is shifted toward the downstream side in the surface moving direction of the fixing roller 26. Further, by detecting an occurrence of an abnormal separation of the recording sheet P in the separation portion “α”, an occurrence of a sheet jam in the fixing device 25 can be predicted. Because an occurrence of a sheet jam can be predicted, necessary maintenance, such as replacement and repair of deteriorated component parts, can be performed in advance before a sheet jam occurs, thereby reducing the amount of downtime.

Further, by predicting an occurrence of a sheet jam based on a detection result, such as an occurrence number or an occurrence rate of the abnormal separation of the recording sheet P, the accuracy of the prediction of an occurrence of a sheet jam can be enhanced.

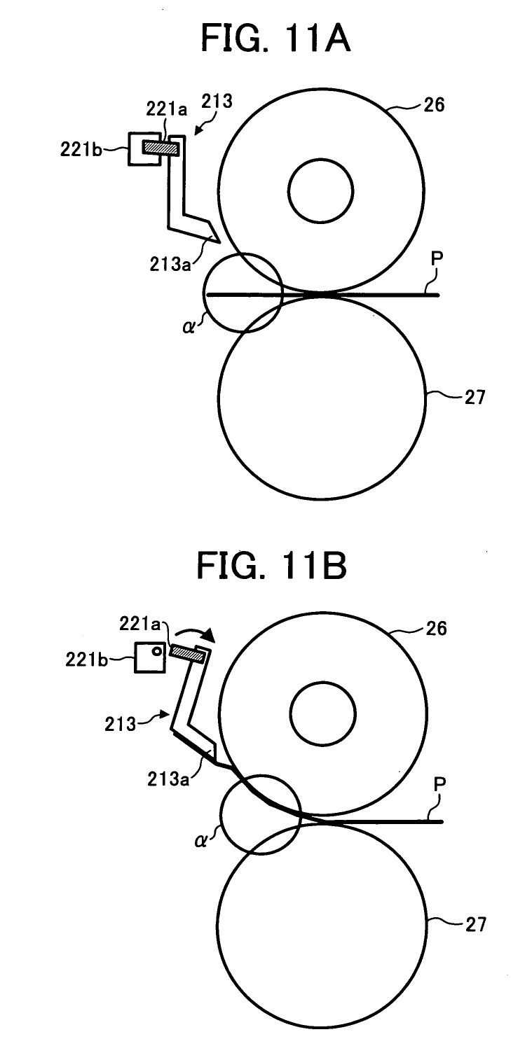

The fixing device of FIGS. 7A and 7B uses the separation pick 203 acting as a contact-type recording medium separating member to separate the recording sheet P causing an abnormal separation from the fixing roller 26. Alternatively, a non-contact-type recording medium separating member such as a non-contact-type separation blade 213 may be used in the fixing device 25 as illustrated in FIGS. 11A and 11B. FIG. 11A is a schematic view of a part of the fixing device 25 illustrating a state where the recording sheet P is normally separated from the fixing roller 26 in the separation portion “α”. FIG. 11B is a schematic view of a part of the fixing device 25 illustrating a state where the recording sheet P is not normally separated from the fixing roller 26 in the separation portion “α”.

The separation pick 203 always contacts the fixing roller 26 although the separation pick 203 does not act all the time. If the separation pick 203 always contacts the fixing roller 26, the surface of the fixing roller 26 may be gradually damaged due to the contact with separation pick 203. As a result, an abnormal image may be formed. For this reason, the non-contact-type separation blade 213 in a shape of a thin plate may be used in the fixing device 25. The separation blade 213 extends in the axial direction of the fixing roller 26. Such a non-contact-type recording medium separating member may oppose the entire area of the fixing roller 26 in its axial direction without the necessity of taking deflections in the axial direction of the fixing roller 26 into consideration.

The separation blade 213 includes a rotation shaft 213a at its leading edge portion, and is configured to rotate. Further, an optical detection plate 221a is provided on a side edge portion of the separation blade 213, which is located on a side opposite from the leading edge portion of the separation blade 213, and which is an end portion in the shaft direction of the rotational shaft 213a. Further, a light sensor 221b is provided to detect that the optical detection plate 221a is located at a predetermined position when the separation blade 213 is in a state illustrated in FIG. 11A.

When the recording sheet P is removed from the fixing roller 26 by the separation blade 213, the separation blade 213 is pushed up by the recording sheet P, and rotates around the rotation shaft 213a in a direction indicated by an arrow in FIG. 11B. When the separation blade 213 rotates, the optical detection plate 221a is away from a detecting portion of the light sensor 221b, and the light sensor 221b detects that the optical detection plate 221a is not located at the predetermined position shown in FIG. 11A. Thus, an abnormal separation between the recording sheet P and the fixing roller 26 can be detected with the light sensor 221b. As described above, because the separation blade 213 opposes the entire area of the fixing roller 26 in its axial direction, the contact of the recording sheet P with the separation blade 213 can be detected in the entire area of the separation blade 213 in the axial direction of the fixing roller 26.

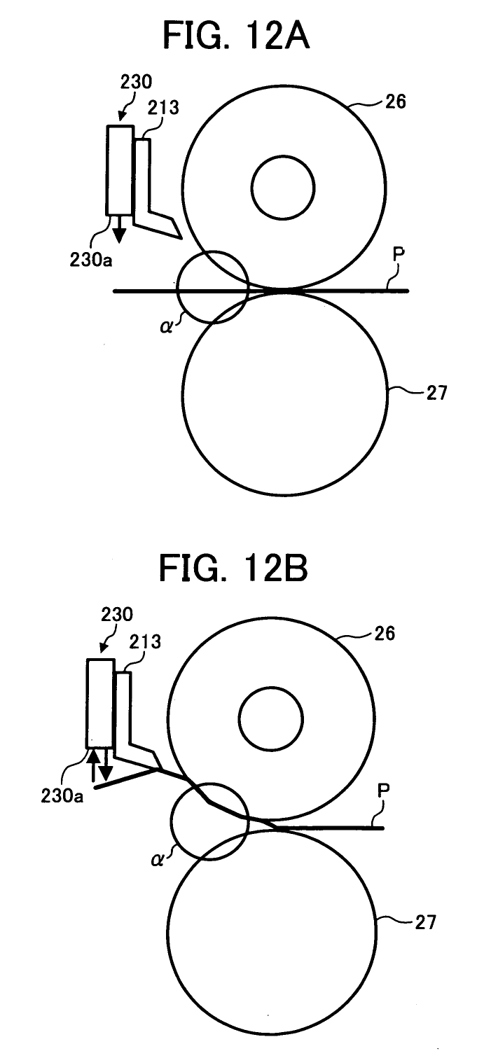

In the fixing device of FIGS. 7A and 7B, an abnormal track of the recording sheet P is detected by the contact of the recording sheet P with the recording sheet lever 210a of the separation pick contact sensor 210. Alternatively, an abnormal track of the recording sheet P may be detected by a light reflection type sensor 230 that includes a light emitting/receiving portion 230a as illustrated in FIGS. 12A and 12B. FIG. 12A is a schematic view of a part of the fixing device 25 illustrating a state where the recording sheet P is normally separated from the fixing roller 26 in the separation portion “α”. FIG. 12B is a schematic view of a part of the fixing device 25 illustrating a state where the recording sheet P is not normally separated from the fixing roller 26 in the separation portion “α”. In the fixing device of FIGS. 12A and 12B, the light reflection type sensor 230 is disposed adjacent to the non-contact-type separation blade 213 such that the light emitting/receiving portion 230a directs toward a conveyance path of the recording sheet P. The light reflection type sensor 230 detects the recording sheet P when a light emitted from the light emitting/receiving portion 230a is reflected on the recording sheet P and the light reflected from the recording sheet P enters the light emitting/receiving portion 230a. By using the light reflection type sensor 230, the recording sheet P moved to a position adjacent to the separation blade 213 can be detected even though the recording sheet P does not contact the separation blade 213. By using a reflected light amount as analog data instead of digital data, continual data corresponding to the track of the recording sheet P can be obtained. The continual data is useful in enhancing the accuracy of the prediction of an occurrence of a sheet jam. By disposing a plurality of the light reflection type sensors 230, the track of the recording sheet P can be detected at plural points, resulting in the increase of the prediction accuracy of an occurrence of a sheet jam. If the light reflection type sensor 230 can detect the intensity of the reflected light, the light reflection type sensor 230 can detect the distance between the light emitting/receiving portion 230a and a recording sheet passing position.

An irregular area where the recording sheet P does not pass in a normal state varies depending on the rigidity of the recording sheet P and a ratio of an image area on the recording sheet P. If the recording sheet P having a high rigidity and a low image area ratio causes an abnormal separation, a separation position where the recording sheet P is separated from the fixing roller 26 does not shift much toward the downstream side of the nip part “N” in the surface moving direction of the fixing roller 26. Therefore, an irregular area where such a recording sheet P does not pass in a normal state includes an area away from the light emitting/receiving portion 230a. In contrast, the separation position of the recording sheet P having a low rigidity and a high image area ratio is likely to shift toward the downstream side of the nip part “N” in the surface moving direction of the fixing roller 26 even though the recording sheet P does not cause an abnormal separation. Therefore, an irregular area where such a recording sheet P does not pass in a normal state includes an area adjacent to the light emitting/receiving portion 230a.

By using the light reflection type sensor 230 that detects the distance between the light emitting/receiving portion 230a and the recording sheet P, the CPU 209 can determine whether the recording sheet P passes through an irregular area based on a detection signal of the light reflection type sensor 230. Thus, this configuration allows the prediction accuracy of an occurrence of a separation failure to enhance.

Further, by detecting the distance between the light emitting/receiving portion 230a and the recording sheet P as analog data, the light reflection type sensor 230 may detect an occurrence of an abnormal separation shown in FIG. 9B.

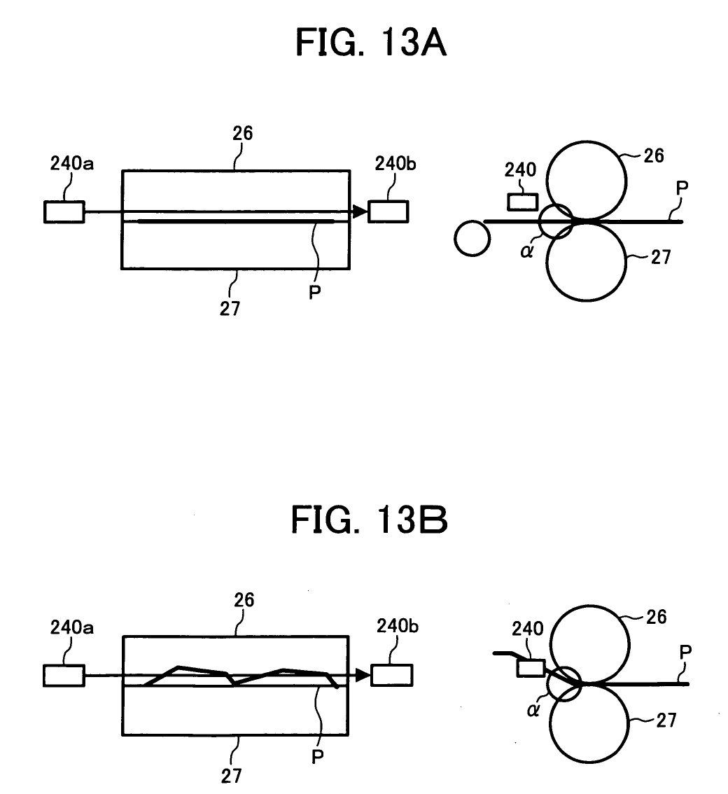

As an alternative to the light reflection type sensor 230, a light transmission type sensor 240 may be used as illustrated in FIGS. 13A and 13B. FIG. 13A is a schematic view of a part of the fixing device 25 illustrating a state where the recording sheet P is normally separated from the fixing roller 26 in the separation portion “α”. FIG. 13B is a schematic view of a part of the fixing device 25 illustrating a state where the recording sheet P is not normally separated from the fixing roller 26 in the separation portion “α”.

The light transmission type sensor 240 is disposed on a downstream side of the separation portion “α” in a surface moving direction of the fixing roller 26, and includes a light emitting portion 240a and a light receiving portion 240b. The light emitting portion 240a emits a light in parallel to the axial direction of the fixing roller 26 toward the light receiving portion 240b. When the recording sheet P enters a light path formed between the light emitting portion 240a and the light receiving portion 240b, the light emitted from the light emitting portion 240a is interrupted by the recording sheet P, so that the light receiving portion 240b does not receive the light. Thus, an abnormal track of the recording sheet P can be detected. By using the light transmission type sensor 240, an abnormal separation caused by the partial recording sheet P can be detected.

In the configurations described with reference to FIGS. 7A through 13B, an abnormal separation of the recording sheet P from the fixing roller 26 is detected by detecting an abnormal track of the recording sheet P. However, the configuration for detecting an abnormal separation of the recording sheet P from the fixing roller 26 is not limited thereto.

As the separability between the recording sheet P and the fixing roller 26 decreases, the separation position where the recording sheet P is separated from the fixing roller 26 shifts toward the downstream side of the nip part between the fixing roller 26 and the pressure roller 27 in the surface moving direction of the fixing roller 26. In this condition, the recording sheet P passes through an irregular area where the recording sheet P does not pass in a normal state, so that a sheet arrival time to a predetermined conveyance path of the recording sheet P is delayed. To detect the delay of this sheet arrival time, a recording medium abnormal conveyance time detecting unit that detects an abnormality in a conveyance time of the recording sheet P may be used in the fixing device 25. As a non-limiting example, the trigger 208 and the jam sensor 202 may be used as the recording medium abnormal conveyance time detecting unit. Hereafter, the configuration for detecting an abnormal separation of the recording sheet P based on the detection results of the trigger 208 and the jam sensor 202 and based on the detection result of the recording sheet rigidity sensor 310 is described.

When an abnormal separation of the recording sheet P occurs in the separation portion “α”, a time interval between the trigger signal output from the trigger 208 and the sheet passage signal output from the jam sensor 202 is greater than that in a normal state. However, such a time interval also increases if a sheet conveyance speed of the conveyance rollers gets lower due to the wear of the conveyance rollers. For this reason, the detection result of the recording sheet rigidity sensor 310 needs to be taken into consideration.

Specifically, an occurrence of an abnormal separation of the recording sheet P may be determined in the following condition: a time interval between the trigger signal output from the trigger 208 and the sheet passage signal output from the jam sensor 202 does not increase much when the recording sheet P having a high rigidity and a tendency not to be adhered to the fixing roller 26 is conveyed in the fixing device 25, and the time interval increases when the recording sheet P having a low rigidity and a tendency to be adhered to the fixing roller 26 is conveyed in the fixing device 25. If the sheet conveyance speed of the conveyance rollers gets lower due to the wear of the conveyance rollers, the sheet conveyance speed gets lower irrespective of the rigidity of the recording sheet P. The reason whey the time interval increases when the recording sheet P having a low rigidity is conveyed in the fixing device 25 is that an abnormal separation occurs between the recording sheet P and the fixing roller 26.

In the configuration for predicting an occurrence of a sheet jam by detecting an abnormal separation of the recording sheet P from the fixing roller 26 based on the detection results of the trigger 208 and the jam sensor 202 and based on the detection result of the recording sheet rigidity sensor 310, an additional detecting unit, such as a sensor, need not be provided on the downstream side of the fixing roller 26 in the sheet conveying direction, thereby reducing the number of parts and the cost of the apparatus. Instead of taking the rigidity of the recording sheet P into consideration for detecting an abnormal separation of the recording sheet P, the thickness of the recording sheet P may be taken into consideration. In this case, an abnormal separation of the recording sheet P from the fixing roller 26 may be detected based on the detection results of the trigger 208 and the jam sensor 202 and based on the detection result of the above-described recording medium thickness detecting unit.

In the fixing device 25 described with reference to FIGS. 7A through 13B, the configuration for detecting an abnormal separation of the recording sheet P from the fixing roller 26 acting as a recording medium conveyance member is described. The recording medium conveyance member that conveys a recording medium while moving and contacting the recording medium is not limited to the fixing roller 26. If an abnormal separation occurs between the intermediate transfer belt 10 and the recording sheet P in the secondary transfer device 22, a recording medium abnormal separation detecting unit may be provided in a separation portion where the recording sheet P is separated from the intermediate transfer belt 10. An occurrence of a sheet jam in the secondary transfer device 22 may be obviated by predicting an occurrence of the abnormal separation of the recording sheet P based on the detection result of the recording medium abnormal separation detecting unit.

Alternatively, the recording medium conveyance member that conveys a recording medium while moving and contacting the recording medium may be sheet conveying rollers such as the registration rollers 49. An abnormal separation of the recording sheet P may occur on a downstream side of the sheet conveying rollers in a sheet conveying direction. Because a diameter of the sheet conveying roller is small as compared to that of the fixing roller 26, the recording sheet P is not likely to be wrapped around a part of the circumferential surface of the sheet conveying roller. However, a track of the recording sheet P after passing through the nip part between the sheet conveying rollers may be changed due to an abnormal separation of the recording sheet P from the sheet conveying rollers, a sheet jam may occur due to the contact of the recording sheet P and a member, such as a sheet guide plate, disposed adjacent to a sheet conveyance path. Therefore, a recording medium abnormal separation detecting unit may be provided in a separation portion where the recording sheet P is separated from the sheet conveying rollers. An occurrence of a sheet jam in the sheet conveyance path may be obviated by predicting an occurrence of the abnormal separation of the recording sheet P based on the detection result of the recording medium abnormal separation detecting unit.

Alternatively, the recording medium conveyance member that conveys a recording medium while moving and contacting the recording medium may be the photoreceptors 40K, 40Y, 40M, 40C, if the respective toner images formed on the photoreceptors 40K, 40Y, 40M, 40C are directly transferred to the recording sheet P.

In the fixing device 25 described with reference to FIGS. 7A through 13B, by detecting an abnormal track of the recording sheet P, an occurrence of an abnormal separation of the recording sheet P can be detected, in which the position where the recording sheet P is separated from the fixing roller 26 in the separation portion “α” is shifted toward the downstream side in the surface moving direction of the fixing roller 26. Further, by detecting an occurrence of an abnormal separation of the recording sheet P in the separation portion “α”, an occurrence of a sheet jam in the fixing device 25 can be predicted. Because an occurrence of a sheet jam can be predicted, necessary maintenance, such as replacement and repair of deteriorated component parts, can be performed in advance before a sheet jam occurs, thereby reducing the amount of downtime.

Next, a description is made of a configuration for predicting an occurrence of a sheet jam not only in the fixing device 25 but also in the entire image forming apparatus of FIG. 1 based on the pieces of information related to the state of the image forming apparatus.

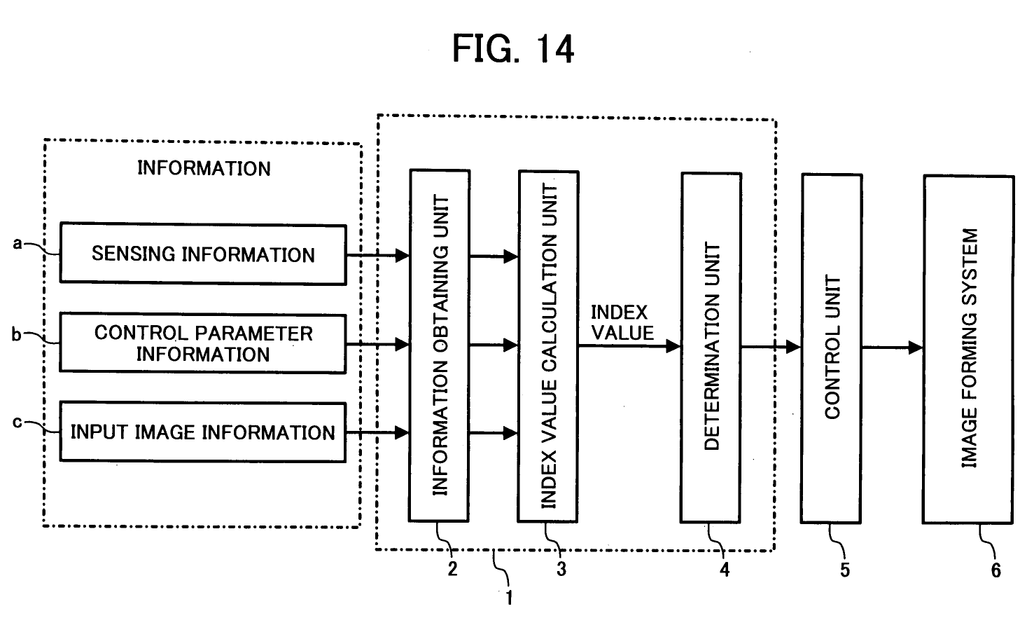

FIG. 14 illustrates a basic configuration of a jam occurrence predicting system. The jam occurrence predicting system includes a state determining apparatus that corresponds to the recording medium conveyance failure occurrence predicting apparatus according to the embodiment of the present invention illustrated in FIG. 8. A state determining apparatus 1 includes an information obtaining unit 2, an index value calculation unit 3, and a determination unit 4 acting as a change of state determining unit. The information obtaining unit 2 obtains a plurality of types of information related to an image forming operation of the image forming apparatus. The index value calculation unit 3 calculates a single index value based on the plurality of types of information obtained by the information obtaining unit 2. The determination unit 4 determines (or predicts) change in a subsequent state of the image forming apparatus based on data related to a temporal change in the index value calculated by the index value calculation unit 3. The data related to a temporal change in the index value calculated by the index value calculation unit 3 and data related to the determination result of the determination unit 4 may be used by the control unit 5 that controls the various devices in an image forming system 6. The image forming system 6 includes the image forming apparatus of FIG. 1 and external apparatuses, such as personal computers, connected to the image forming apparatus via communication lines.

The information obtaining unit 2 obtains various types of information (described below), and includes a communication interface or the like that performs data communication among various sensors that detect various types of sensing information, the control unit 5, and an image data processing unit (not shown). The information obtaining unit 2 transmits a data obtaining request to the various sensors, the control unit 5, and the image data processing unit. As a result, the information obtaining unit 2 receives various sensing information data from the various sensors, control parameter information data from the control unit 5, and input image information data from the image data processing unit.

The control unit 5 includes a CPU, RAM, ROM, an I/O interface unit. The index value calculation unit 3 and the determination unit 4 may be provided independently of the control unit 5 as devices configured by a unique large-scale integration (LSI) or the like, or may be constituted by sharing hardware resources such as a CPU that constructs the control unit 5.

The information obtained by the information obtaining unit 2 and input to the index value calculation unit 3 includes sensing information “a”, control parameter information “b”, and input image information “c”.

The sensing information “a” includes data obtained by the various sensors provided within or around the image forming apparatus. Examples of such sensing information “a” include the dimensions of the units of the apparatus, the speed of the movable members in the apparatus, time (timing), weight, current value, potential, oscillation, sound, magnetic force, light intensity, temperature, and humidity.

The control parameter information “b” is general information which accumulates as a result of control of the apparatus. Examples of the control parameter information “b” include an operation history of a user, power consumption, toner consumption amount, the setting history of various image forming conditions, and the warning history.

The input image information “c” is obtained from information input to the image forming system 6 as image data. Examples of the input image information “c” include the cumulative number of color pixels, the ratio of a character portion, the ratio of a halftone portion, the ratio of colored characters, the toner consumption distribution in the main scanning direction, RGB signals (total toner amount per pixel unit), the size of an original document, an original document with a frame, and the character type (size and font).

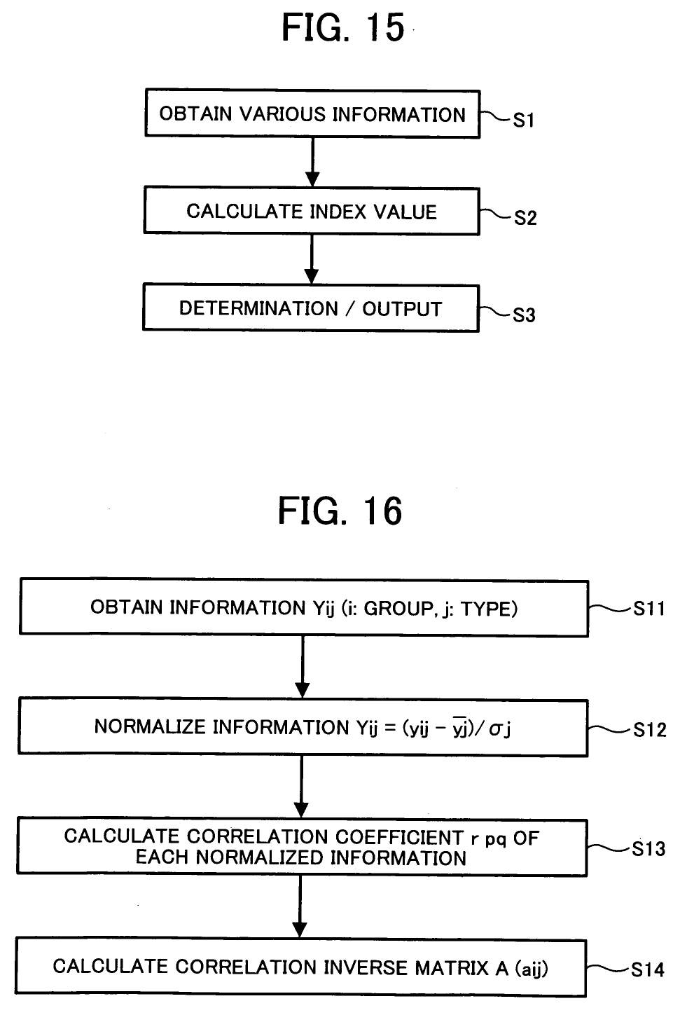

FIG. 15 is a flowchart of a basic operation of the jam occurrence predicting system. First, the above-described plurality of types of information, which is assumed to be related to the state of the image forming apparatus, is input to the state determining apparatus 1 of the jam occurrence predicting system, and the information obtaining unit 2 obtains the plurality of types of information at a required timing in step S1. Subsequently, the index value calculation unit 3 calculates a single index value based on the obtained information according to a predetermined calculation method in step S2. Data regarding temporal change in the calculated index value is used to determine an occurrence of jam in the image forming apparatus, or is output to a display unit or an external apparatus in step S3.

Before calculating the index value, an index value calculation method (calculation expression) must be determined. In this embodiment, a multi-dimensional space is defined with different coordinate axes for each of the input plurality of information, and the index value is calculated as a distance in the multi-dimensional space. Therefore, a plurality of groups of the information obtained in step S1 in FIG. 15 are obtained during the image forming apparatus operates in a normal state.

FIG. 16 is a flowchart showing a procedure for determining the calculation method (calculation expression) of the index value. First, “n” groups of “k” types of information relating to the condition of the image forming apparatus is obtained in step S11. The information is obtained in the manner described above, and a specific example of which is described hereafter.

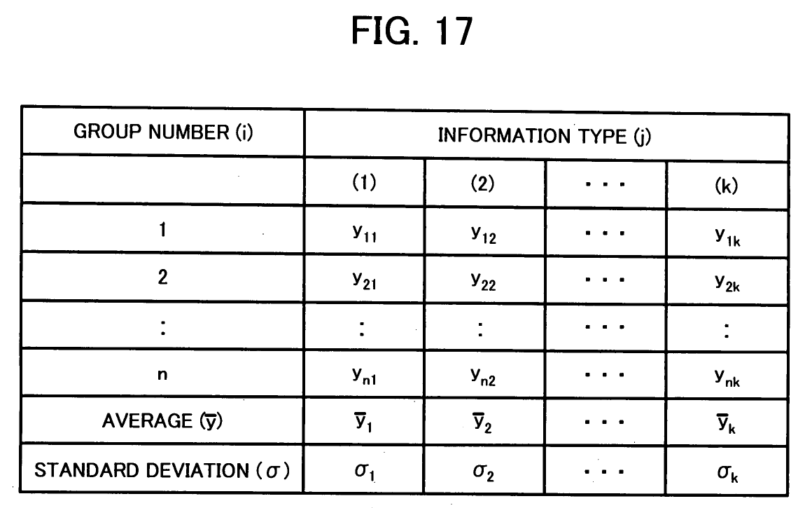

FIG. 17 is a table showing a configuration of data of the obtained information. Under the initial condition (for example, the first day, first machine, etc.), “k” types of data are obtained. These data are defined as y₁₁, y₁₂ . . . , y₁ₖ. The data obtained similarly under the next condition (the second day, second machine, etc.) are defined as y₂₁, y₂₂ . . . , y₂ₖ. Thus, “n” groups of data are obtained.

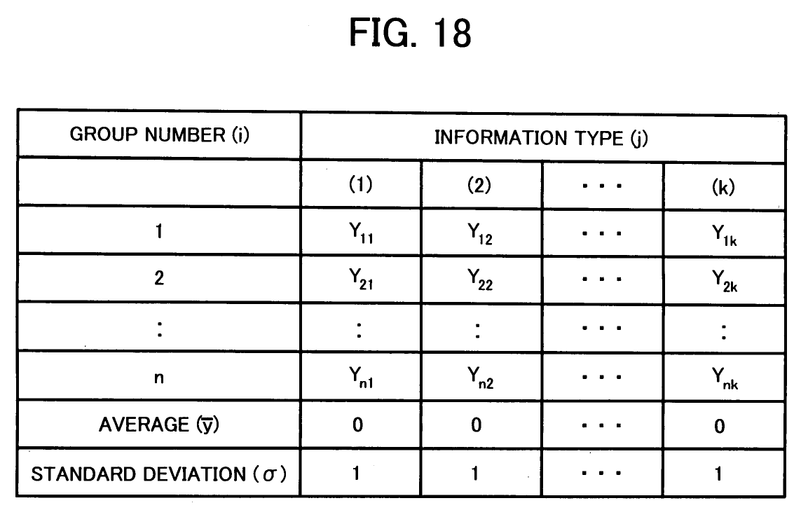

Next, raw data (for example, yij) is normalized for each information type (j) by an average value (yj) and a standard deviation (σj) in step S12. FIG. 18 is a table showing a result of normalization of the data shown in FIG. 17, which is obtained based on the following equation (1).
Yᵢⱼ=(yᵢⱼ−\overline{yⱼ}/σⱼ (1)
where “i” is any one of the “n” sets of grouped information, and “j” is any one of the “k” types of information.

Next, all of the correlation coefficient r_{pq} (r_{qp}) between two groups of data from among the “k” types of information are calculated based on the following equation (2), and these correlation coefficients are expressed as a correlation coefficient matrix R as shown in the following equation (3) in step S13.

Then, an inverse matrix of the correlation coefficient matrix R is calculated, and the result of the calculation is expressed as a correlation inverse matrix A (aij) as shown in the following equation (4) in step S14. The symbol “Σ” in the equation (2) denotes the sum relating to the suffix “i”.

$$\begin{matrix}{r}_{pq} = {r}_{qp} = \frac{\sum ( {Y}_{ip} {Y}_{iq} )}{{( \sum {Y}_{ip}^{2} \sum {Y}_{iq}^{2} )}^{1 / 2}} & ( 2 ) \\ R = ( \begin{matrix}1 & {r}_{12} & {r}_{13} & … & {r}_{1 k} \\ {r}_{21} & 1 & {r}_{23} & … & {r}_{2 k} \\ {r}_{31} & {r}_{32} & 1 & … & {r}_{3 k} \\ … & … & … & … & … \\ {r}_{k1} & {r}_{k2} & {r}_{k3} & … & 1\end{matrix} ) & ( 3 ) \\ A = ( \begin{matrix}{a}_{11} & {a}_{12} & {a}_{13} & … & {a}_{1 k} \\ {a}_{21} & {a}_{22} & {a}_{23} & … & {a}_{2 k} \\ {a}_{31} & {a}_{32} & {a}_{33} & … & {a}_{3 k} \\ … & … & … & … & … \\ {a}_{k1} & {a}_{k2} & {a}_{k3} & … & {a}_{kk}\end{matrix} ) = {R}^{- 1} & ( 4 )\end{matrix}$$

By these processes, the value of the calculation parameter in the calculation equation used when calculating the single index value is determined. The data sets here all indicate a normal state, and it is therefore assumed that the various types of obtained information have a fixed correlation. When the image forming apparatus deviates from a normal state and it appears that a sheet jam may occur, these correlations become unbalanced such that the “distance” from the origin (stable state average) in the multi-dimensional space defined as described above increases. This “distance” serves as the index value.

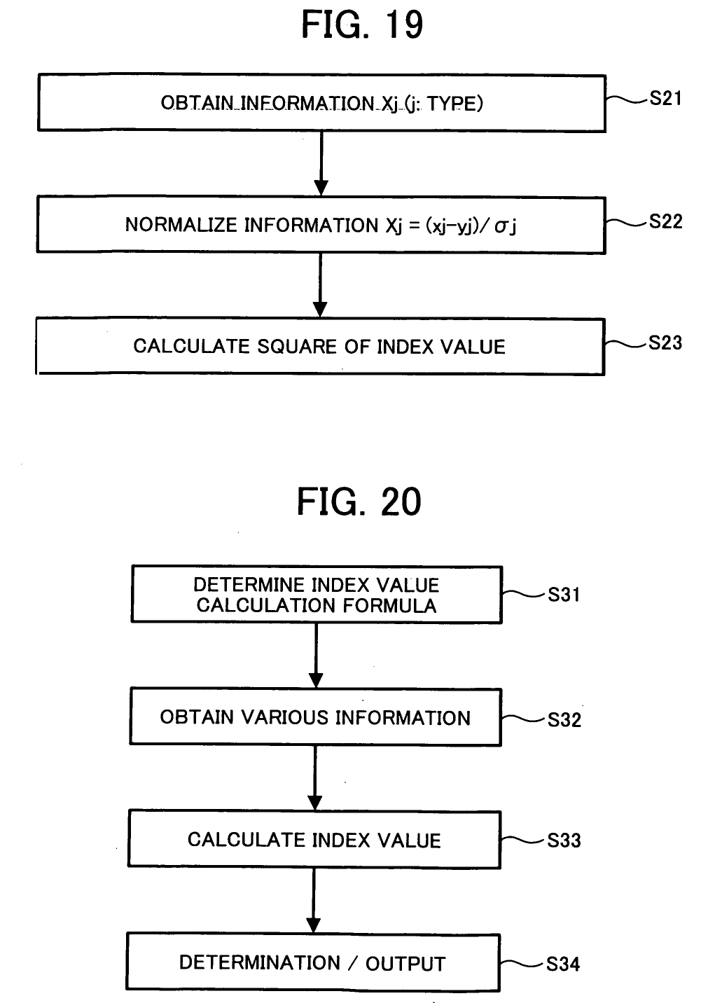

FIG. 19 is a flowchart showing a procedure for calculating the index value in step S2 in FIG. 15. The index value at an arbitrary timing is obtained in the following manner. First, “k” types of data x1, x2, . . . , xk in any condition are obtained in step S21. The data types correspond to y11, y12, . . . , y1k, and so on. Next, the obtained data is normalized respectively to X1, X2, . . . , Xk based on the following equation (5) in step S22. Then, the square of the index value is calculated by using the following equation (6) which is determined using the element aₖₖ of the obtained inverse matrix A in step S23. The symbol “D” in the equation (6), which is the square of the index value, is known as a “Mahalanobis distance”. Further, the symbol “Σ” in the equation (6) denotes the sum relating to the suffixes “p” and “q”.
Xⱼ=(xⱼ−yⱼ)/σⱼ (5)
D²=(1/k)Σa_{pq}XₚX_{q} (6)

The processing for determining the calculation method of the index value or the calculation expression of the index value, and the processing for calculating and updating the index value “D” based on this calculation expression may be performed continuously during operation of the image forming system 6. In the processing flowchart in this case, the processing steps of FIG. 15 and the processing steps of FIG. 16 are combined, as shown in the flowchart of FIG. 20. Specifically, the calculation expression of the index value is determined in step S31 by performing the processing steps S11 through S14 in FIG. 16. Then, the processing steps S32 through S34 are performed similarly as in steps S1 through S3 in FIG. 15.

The types of information to be obtained to predict an occurrence of a sheet jam in the image forming apparatus of FIG. 1 and the method of obtaining this information are described hereafter.

(a) Sensing Information

The items that may be obtained as sensing information include driving relationships, various characteristics of a recording medium, developer characteristics, photoreceptor characteristics, various states of an electrophotographic process, environmental conditions, and various characteristics of recorded objects. An outline of these various types of sensing information is described below.

(a-1) Driving Information Includes:
detecting the rotation speed of a photoreceptor with an encoder, reading the current value of a drive motor, reading the temperature of the drive motor;
similarly detecting the driving condition of cylindrical or belt-shaped rotating components, such as, a fixing roller, a conveyance roller, a drive roller, and so on; and
detecting sounds caused by driving with a microphone disposed within or outside of the device.

(a-2) Sheet Conveyance Conditions Include:
reading the position of the leading edge/trailing edge of the conveyed sheet with a transmission type or reflection type optical sensor, or a contact type sensor, detecting the occurrence of a sheet jam, and reading deviations in the passage timing of the leading edge/trailing edge of the sheet, or variation in a direction perpendicular to a sheet conveyance direction;
similarly determining a moving speed of a sheet based on the detection timing of a plurality of sensors; and
determining slippage between a sheet feeding roller and a sheet during sheet feeding by comparing a measured value of the number of rotations of the sheet feeding roller to a moving amount of the sheet.

(a-3) Various Characteristics of a Recording Medium Such as a Sheet

This information greatly affects image quality and sheet conveyance stability. The following methods are used to obtain information relating to the type of sheet.

The thickness of a sheet is determined by fixing the sheet between two rollers and detecting relative positional displacement of the rollers with an optical sensor or the like, or detecting an equal displacement to the travel of a member that is pushed upward when the sheet is introduced.

The surface roughness of the sheet is determined by causing a guide or the like to contact the surface of the sheet prior to transfer, and detecting the oscillation, sliding sound, or the like produced by this contact.

The gloss of the sheet is determined by irradiating luminous flux of a prescribed angle of aperture at a prescribed angle of incidence, and measuring the luminous flux of a prescribed angle of aperture that is reflected in a specular reflection direction with a sensor.

The rigidity of the sheet is determined by detecting the amount of deformation (curvature) of a pressed piece of sheet.

A determination as to whether or not the sheet is a recycled sheet is performed by irradiating the sheet with ultraviolet light and detecting its transmittivity.

A determination as to whether or not the sheet is a backing sheet is performed by irradiating the sheet with light from a linear light source such as an LED array, and detecting the light reflected from the transfer surface with a solid state imaging element such as a CCD.

A determination as to whether or not the sheet is an OHP sheet is performed by irradiating the sheet with light, and detecting regular reflection light having a different angle to that of the transmitted light.

The moisture content of the sheet is determined by measuring the absorption of infrared light or μ wave light.

The curl is detected using an optical sensor, contact sensor, or the like.

The electric resistance of the sheet is determined by causing a pair of electrodes (sheet feeding rollers or the like) to contact the recording sheet and measuring the electric resistance directly, or measuring the surface potential of the photoreceptor or intermediate transfer element following transfer, and estimating the resistance value of the recording sheet from the measured value.

(a-4) Developer Characteristics

The characteristic of the developer (toner/carrier) in the device fundamentally affects the electrophotographic process function, and are therefore an important factor in the operation and output of the system. It is beneficial to obtain information regarding developer. The following items may be cited as examples of developer characteristics.

With regard to toner, the charging amount and distribution, fluidity, cohesion, bulk density, electric resistance, external additive amount, consumption amount or remaining amount, fluidity, and toner concentration (mixing ratio of toner and carrier) may be cited as characteristics.

With regard to carrier, the magnetic property, coating thickness, spent amount, and so on may be cited as characteristics.

It is usually difficult to detect items such as those described above individually in the image forming apparatus. Therefore, an overall characteristic of the developer is detected. The overall characteristic of the developer may be measured in the following ways, for example.

A test latent image is formed on the photoreceptor, developed under predetermined developing conditions, and the reflection density (optical reflectance) of the formed toner image is measured.

A pair of electrodes are provided in the developing device, and the relationship between the applied voltage and current (resistance, permittivity, and so on) is measured.

A coil is provided in the developing device, and the voltage-current characteristic (inductance) is measured.

A level sensor is provided in the developing device, and the developer volume is detected. The level sensor may be an optical sensor, a capacitance sensor, or the like.

(a-5) Photoreceptor Characteristics

Similarly to the developer characteristics, the photoreceptor characteristics relate closely to the electrophotographic process function. Examples of information regarding the photoreceptor characteristics include the photosensitive film thickness, the surface characteristics (coefficient of friction, irregularities), surface potential (before and after each process), surface energy, scattered light, temperature, color, surface position (deflection), linear speed, potential attenuation speed, resistance/capacitance, surface moisture content, and so on. From among these examples, the following information can be detected in the image forming apparatus.

Variation in the capacitance accompanying film thickness variation can be detected by detecting the current flowing from a charging member to the photoreceptor, and simultaneously comparing the voltage applied to the charging member with the voltage-current characteristic relating to a preset dielectric thickness of the photoreceptor to determine the film thickness.

The surface potential and temperature can be determined by a known sensor.

The linear speed is detected by an encoder or the like attached to a rotary shaft of the photoreceptor.

Scattered light from the surface of the photoreceptor is detected by an optical sensor.

(a-6) State of the Electrophotographic Process

As is known, toner image formation through electrophotography is performed by a succession of processes including: uniform charging of the photoreceptor; latent image formation (image exposure) by using laser light or the like; development using toner (coloring particles) carrying an electric charge; transfer of the toner image onto a transfer material (in the case of a color image, this is performed by superposing toner images onto an intermediate transfer element or the recording medium, which is the final transfer element, or by superposition development onto the photoreceptor during development); and fixing of the toner image on the recording medium. The various information at each of these stages greatly affects the image and other system output. It is important to obtain the various information to evaluate the stability of the system. Specific examples of obtaining information relating to the state of the electrophotographic process are as follows:
the charging potential and exposure unit potential are detected by a known surface potential sensor;
the gap between the charging member and photoreceptor in non-contact charging is detected by measuring the amount of light passing through the gap;
the electromagnetic wave caused by charging is perceived by a wideband antenna;
the sound generated by charging;
the exposure intensity; and
the exposure optical wavelength.

Further, the following can be cited as methods of obtaining various states of the toner image.

The pile height (height of the toner image) is detected by measuring depth from the vertical direction using a displacement sensor, and measuring shielding length from the horizontal direction using a parallel ray linear sensor.

The toner charging amount is measured by a potential sensor which measures the potential of an electrostatic latent image on a solid portion and the potential when the latent image has been developed, and determined from the ratio thereof to an adhesion amount calculated by a reflection density sensor in the same location.

Dot fluctuation or scattering is determined by detecting a dot pattern image using an infrared light area sensor on the photoreceptor and area sensors of wavelengths corresponding to each color on the intermediate transfer element, and then implementing appropriate processing.

The offset amount (after fixing) is read by optical sensors in locations corresponding to the surface of the recording sheet and the surface of the fixing roller respectively, and determined by comparing the two obtained sensor values.

The remaining transfer amount is determined by disposing optical sensors after the transfer step (on the PD and the belt) and measuring the amount of reflected light from the remaining transfer pattern following the transfer of a specific pattern.

Color unevenness during superposition is detected by a full color sensor which detects the surface of the recording sheet following fixing.

(a-7) Formed Toner Image Characteristics

Image density and color are detected optically (by either reflected light or transmitted light; the projection wavelength is selected according to the color). To obtain density and single color information, this detection may be performed on the photoreceptor or intermediate transfer element, but to measure a color combination, such as color unevenness, the detection must be performed on the sheet.

Gradation is determined using an optical sensor by detecting the reflection density of a toner image formed on the photoreceptor or a toner image transferred onto a transfer element at each gradation level.

Definition is detected using a monocular sensor with a small spot diameter or a high resolution line sensor by reading a developed or transferred image to determine a repeated line pattern.

Graininess (roughness) is determined by the same method used to detect the definition, by reading a halftone image and calculating the noise component.

Registration skew is determined by providing an optical sensor at each end of the main scanning direction following registration, and measuring the difference between the ON timing of the registration rollers and the detection timing of the two sensors.

Mis-color registration is determined by detecting the edge portions of a superposed image on the intermediate transfer element or recording sheet using a monocular small-diameter spot sensor or a high resolution line sensor.

Banding (density unevenness in the conveyance direction) is detected by measuring density unevenness in the sub-scanning direction on the recording sheet using a small-diameter spot sensor or a high resolution line sensor, and measuring the signal quantity at a specific frequency.

Glossiness (unevenness) is detected by providing a piece of a recording sheet formed with a uniform image so as to be scanned by a regular reflection-type optical sensor.

Fogging is detected using a method of reading an image background portion using an optical sensor for scanning a comparatively wide region on the photoreceptor, intermediate transfer element, or recording sheet, or a method of obtaining image information for each area of the background region using a high resolution area sensor, and counting the number of toner particles in the image.

(a-8) Physical Characteristics of Printed Objects in the Image Forming Apparatus

Image deletion/fading and so on is determined by scanning a toner image on the photoreceptor, intermediate transfer element, or recording sheet using an area sensor, and subjecting the obtained image information to image processing.

Scattering is determined by scanning an image on the recording sheet using a high resolution line sensor or an area sensor, and calculating the amount of toner scattered around the periphery of the pattern portion.

Rear end blank spots and betacross blank spots are detected with a high resolution line sensor on the photoreceptor, intermediate transfer element, or recording sheet.

Curling, rippling, and folding are detected with a displacement sensor. It is effective to dispose a sensor in a location close to the two end portions of the recording sheet to detect folding.

Contamination and flaws on the cross-cut surface are detected with an area sensor provided vertically in the sheet discharging tray by capturing an image of and analyzing the cross-cut surface when a certain amount of delivered sheets have accumulated.

(a-9) Environmental Conditions

To detect temperature, the following system and elements may be employed: a thermocouple system which extracts as a signal a thermoelectromotive force generated at a contact point joining two different metals or a metal and a semiconductor; a resistivity variation element using temperature-based variation in the resistivity of a metal or semiconductor; a pyroelectric element in which, with a certain type of crystal, the charge in the crystal is polarized with an increase in temperature to generate a surface potential; and a thermomagnetic effect element which detects change in the magnetic property according to temperature.

To detect humidity, an optical measurement method for measuring the optical absorption of H2O or an OH group, a humidity sensor which measures variation in the electric resistance value of a material due to water vapor adsorption, and so on, may be employed.

Various gases are detected by measuring change in the electric resistance of an oxide semiconductor basically accompanying gas adsorption.

To detect airflow (direction, flow speed, gas type), an optical measurement method or the like may be used, but an air-bridge type flow sensor which enables a reduction in the size of the system due to its small size is particularly useful.

To detect air pressure and pressure, methods such as using a pressure sensitive material to measure the mechanical displacement of a membrane may be employed. Similar methods may be used to detect oscillation.

(b) Control Parameter Information

As an operation of the image forming apparatus is determined by the control unit, it is effective to use the input/output parameters of the control unit directly.

(b-1) Image Formation Parameters

These are direct parameters output as a result of calculation processing performed by the control unit 1 for the purpose of image formation:

Set values of the process conditions set by the control unit 1, for example, the charging potential, developing bias value, and fixing temperature set value;

Similarly, set values of various image processing parameters for halftone processing, color correction, and so on;

Various parameters set by the control unit 1 to operate the device, for example, the sheet conveyance timing, and the execution period of a preparatory mode prior to image formation.

(b-2) User Operating History

The frequency of various operations selected by the user, such as the number of colors, number of sheets, and image quality instructions.

The frequency of sheet size selections by the user.

(b-3) Power Consumption

The total power consumption over the entire period or a specific time unit (one day, one week, one month, etc.), or the distribution, variation (derivative), and cumulative value (integral) thereof.

(b-4) Information Regarding Consumption of Consumables

Usage of the toner, photoreceptor, and sheet over the entire period or a specific time unit (one day, one week, one month, etc.), or the distribution, variation (derivative), and cumulative value (integral) thereof.

(b-5) Information Regarding the Occurrence of a Fault

The frequency with which a fault occurs (by type) over the entire period or a specific time unit (one day, one week, one month, etc.), or the distribution, variation (derivative), and cumulative value (integral) thereof.

(c) Input Image Information

The following information can be obtained from image information transmitted from a host computer as direct data or image information obtained after being read from an original image by a scanner and subjected to image processing.

The cumulative number of color pixels is determined by counting image data by a GRB signal for each pixel.

Using a method such as that described in Japanese Patent Publication No. 2621879, for example, an original image can be divided into characters, halftone dots, photographs, and background, and thus the ratio of the character portion, halftone portion, and so on can be determined. The ratio of colored characters can be determined in a similar manner.

By counting the cumulative value of the color pixels in each of a plurality of regions partitioned in the main-scanning direction, the toner consumption distribution in the main-scanning direction can be determined.

The image size is determined according to image size signals generated by the control unit or the distribution of color pixels in the image data.

The character type (size, font) is determined from attribute data of the characters.

The various information cited above can be obtained by known techniques in a typical image forming apparatus.

Thus, the index value “D” is calculated from these various types of information, and an occurrence of a sheet jam is predicted by determining the latent possibility of an occurrence of a sheet jam based on the index value. Basically, as described above, if the index value “D” is greater than a predetermined threshold value, it is determined that the possibility of an occurrence of a sheet jam is high. This threshold value is generally determined in advance through experiments. Alternatively, the threshold value may be set at an arbitrary initial value (for example, ten), and then updated as data accumulate.

The index value “D” is a gauge indicating the degree to which the correlation between the obtained information has deviated from a normal state. As the index value increases, this deviation from the normal state is determined to be greater. Therefore, even though a mechanism of a sheet jam is unclear, the possibility of an occurrence of a sheet jam can be predicted.

After the index value “D” is calculated, the state of an image forming apparatus is determined based on the index value “D” to predict an occurrence of a sheet jam. A processing method performed thereafter is described below. After the index value is calculated and an occurrence of a sheet jam is predicted, the following processes (d) to (j) may be performed.

(d) Outputting the Calculation Result, State Determination Result, and Sheet Jam Occurrence Prediction Result

Examples of the content of this output include the calculation result of the index value “D” or a numerical value on which the index value is reflected, a determination result indicating a change in the state of the image forming apparatus, and a prediction result indicating the occurrence of a sheet jam due to a fault or end of useful lifetime of a component in the form of a warning notifying a user that a sheet jam is likely to occur. Data related to temporal change in the index value “D” or the numerical value on which the index value “D” is reflected, may be output as a graph. The following are examples of output methods.
(d-1) Display of numerical value data or a message on a display unit such as a liquid crystal display in an operation unit panel or the like.
(d-2) A notification or warning consisting of a voice or a sound of a specific pattern that is output by an audio output unit such as a speaker.
(d-3) Recording on a recording medium (recording sheet)

The result of the process (d) is output to a display unit or an audio output unit provided in the corresponding image forming apparatus, or recorded on a recording medium (recording sheet) and then output. The result may be transferred to a printer server connected via a network, or a monitoring center connected by communication lines to monitor the state of various devices.

(e) Transferring the Calculation Result, State Determination Result, and Sheet Jam Occurrence Prediction Result

Similar content to that described in (d) may be transferred to a printer server or monitoring center.

(f) Storing the the Calculation Result, State Determination Result, and Sheet Jam Occurrence Prediction Result

Similar content to that described in (d) is stored in a storage unit (memory) provided in each image forming apparatus, a printer server, or a device in the monitoring center. The content stored in the storage unit may be read out to perform control.

(g) Halting the Apparatus

If the calculated index value “D” exceeds a predetermined reference value or the increase rate of the index value “D” increases, the image forming apparatus is halted forcibly and maintenance is requested.

(h) Restricting Operations or Changing Control

A related portion is estimated based on both the calculation result of the index value “D” and various information sources. Control change is performed such that an operation related to the portion is restricted. The following are examples of the control change.
(h-1) Change of color mode
(h-2) Change of recording speed
(h-3) Change of the number of halftone lines
(h-4) Change of halftone processing method
(h-5) Restriction of sheet type
(h-6) Change in registration control parameters
(h-7) Change in image forming process parameters (for example, in an electrophotographic image forming apparatus, the charging potential, exposure amount, developing bias, transfer bias, etc.).

(i) Supplying or Replacing Consumables and Components

Supply or replacement is performed automatically based on the calculation result of the index value “D”.

(j) Automatic Repair

When an occurrence of a sheet jam is determined in a specific site based on both the index value “D” and the various information sources, a mode to repair the specific site is executed.

Examples of a method of obtaining specific various information in the image forming apparatus according to the embodiment of the present invention are described hereafter. Types of information used to determine the state of the image forming apparatus and a method of obtaining the various information are not limited to the following information and method.

In this embodiment, individual index values or a single common index value is calculated before a product is shipped, using the image forming apparatus illustrated in FIGS. 1 to 3. After the shipment, the index value is monitored online so that maintenance can be performed when the index value increases. The specific content of the types of information to be obtained and a method of obtaining the information are described below.

(1) Temperature

In this embodiment, a unit using a resistance variation element, which has the simplest principle and structure and which can be microminiaturized, is employed as an information obtaining unit to obtain temperature information.

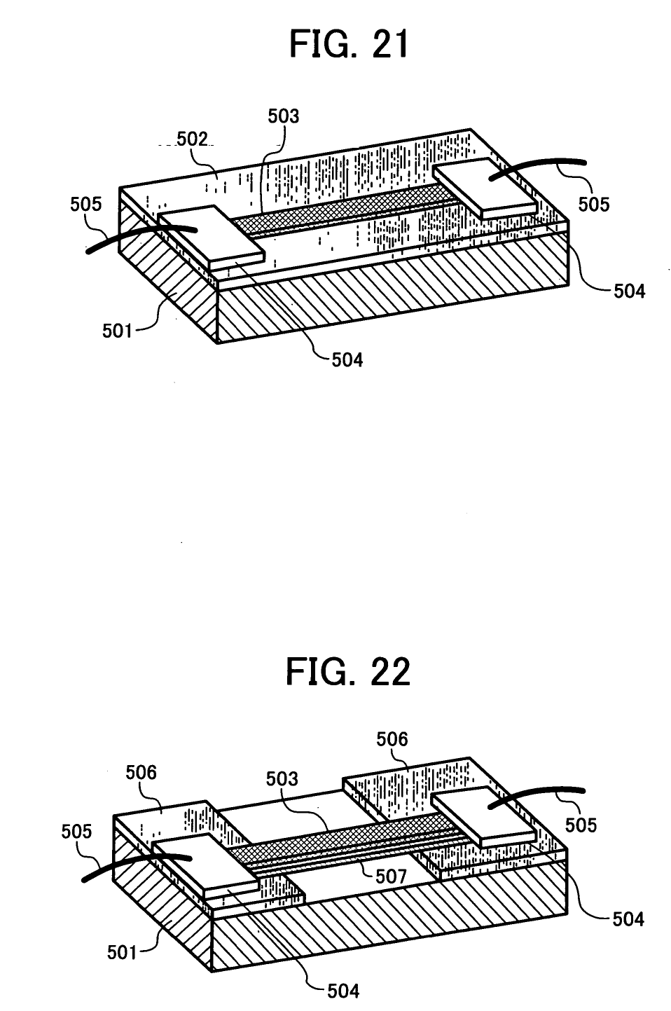

FIG. 21 is a perspective view of a resistance variation element of a thin-film type used in this embodiment. The resistance variation element may be manufactured as follows. First, an insulating film 502 is formed on a substrate 501, and then a thin film-shaped sensor unit 503 formed from a metallic or semiconductor material is disposed on the insulating film 502. Further, pad electrodes 504 are provided at both ends of the sensor unit 503, and finally, lead wires 505 are connected to the pad electrodes 504. In this resistance variation element, the electric resistance of the sensor unit 503 varies with a variation in the ambient temperature, and this variation may be derived as a variation in voltage or current. Because the sense unit 503 is a thin film, the entire element can be reduced in size and can be easily incorporated into the system.

FIG. 22 is a perspective view of another resistance variation element. The resistance variation element in FIG. 22 is different from that in FIG. 21 in that the sense unit 503 is disposed on a thin film bridge 507 that is suspended in midair and separated from the substrate 501 via spacers 506. This structure prevents heat from being scattered and lost from the sense unit 503, and enhances the responsiveness of the sense unit 503 to temperature. Further, this structure allows the sense unit 503 to detect only radiant heat from a portion to be measured, and is preferably used in non-contact measurement.

(2) Humidity

A humidity sensor that can be reduced to a small size is useful. The basic principle thereof is that when a humidity-sensitive ceramic adsorbs water vapor, ion conduction is increased by the adsorbed water such that the electric resistance of the ceramic decreases. The material of the humidity-sensitive ceramic may be a porous material, such as an alumina-based ceramic, apatite-based ceramic, and ZrO2—MgO based ceramic.

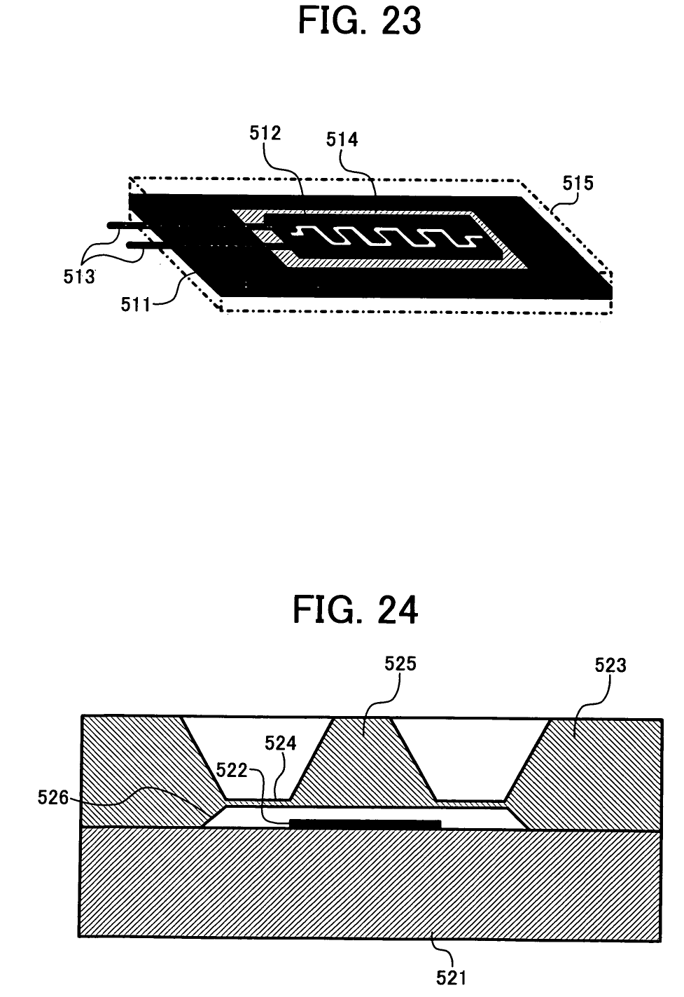

FIG. 23 is a perspective view of a humidity sensor used in this embodiment. A comb-shaped electrode 512 is disposed on an insulating substrate 511, and terminals 513 are connected to both ends of the comb-shaped electrode 512. Further, a humidity-sensitive layer 514 (generally, a humidity-sensitive ceramic) is provided, and the entire sensor is covered with a case 515. When the humidity-sensitive ceramic adsorbs water vapor through the case 515, the electric resistance decreases, and this may be measured as voltage or current variation.

(3) Oscillation

An oscillation sensor is basically the same as a sensor that measures air pressure and pressure. When the oscillation sensor is mounted on the system, a sensor using silicon, which can be microminiaturized, is particularly useful. The motion of an oscillator manufactured on a thin silicon diaphragm can be measured by measuring volumetric change between the oscillator and a counter electrode disposed opposite to the oscillator or by using a piezoresistance effect of the Si diaphragm itself.

FIG. 24 is a sectional view of an oscillation sensor used in this embodiment. A counter electrode 522 is disposed on an insulating substrate 521. Next, a thin diaphragm 524 and an oscillator 525 are disposed on a silicon substrate 523. A stepped portion 526 is then formed to maintain a gap with the counter electrode 522, and joined to the insulating substrate 521 having the counter electrode 522 formed in advance. When peripheral oscillation or pressure is applied to the oscillation sensor in this state, the oscillator 525 begins to oscillate. The oscillation may be measured as volumetric change between the oscillator 525 and the counter electrode 522.

(4) Toner Concentration

A toner concentration is detected for each color. A known sensor may be used as a toner concentration sensor. For example, a toner concentration may be detected with a sensing system described in Published Japanese patent application No. 6-289717, which measures a change in the magnetic permeability of the developer in a developing device.

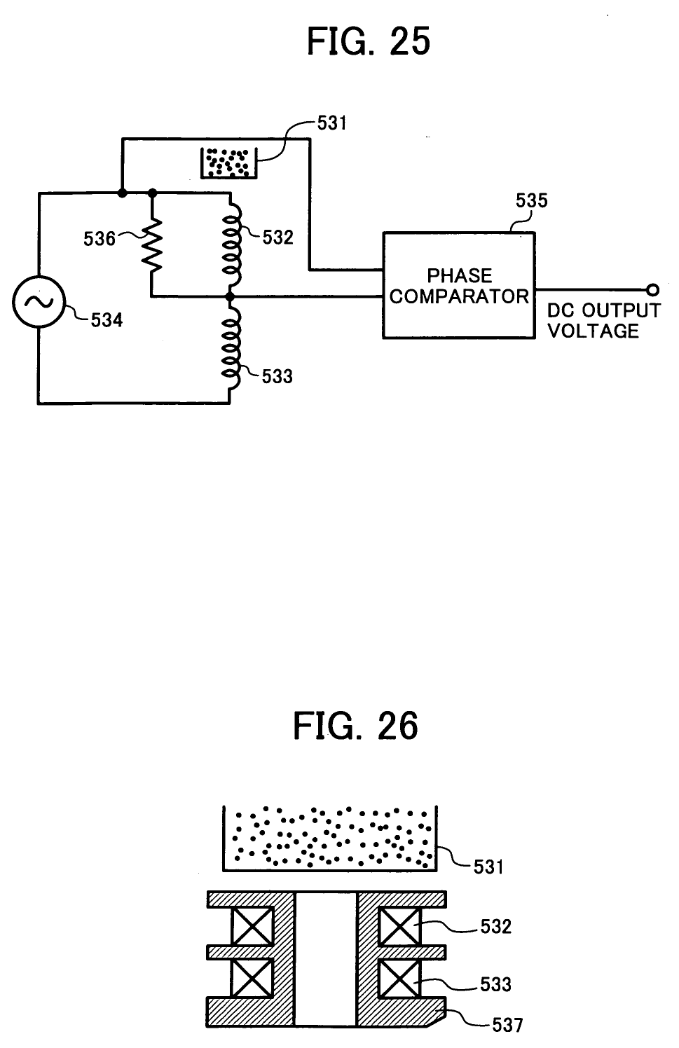

FIG. 25 is a schematic diagram of a circuit configuration of a toner concentration detecting unit. For example, a reference coil 533 is connected differentially to a detection coil 532 disposed adjacent to a developer 531 formed from a mixture of a magnetic carrier and a non-magnetic toner. The inductance of the detection coil 532 varies with a change in the magnetic permeability caused by an increase or decrease in the toner concentration (directly, in the magnetic carrier). However, the inductance of the reference coil 533 is not affected by the change in the toner concentration. An alternating current drive source 534 that oscillates at a frequency of 500 kHz, for example, is connected to the series circuit of the two coils 532 and 533 to drive the two coils 532 and 533. A differential output is derived from the connection point between the coils 532 and 533, and the output is connected to a phase comparator 535. One of the outputs from the alternating current drive source 534 is connected independently to the phase comparator 535, and thus the phase of the voltage and differential output voltage from the drive source 534 are compared with each other.

A sensitivity setting resistor 536 (R1) is connected in parallel to at least one of the two coils, i.e., the detection coil 532 and the reference coil 533. In FIG. 25, the sensitivity setting resistor 536 (R1) is connected to the detection coil 532. The sensitivity characteristic is controlled by decreasing the sensitivity to a change in the toner concentration. FIG. 26 is an assembly diagram of the coils in the toner concentration detecting unit. The two coils 532 and 533 are wound on a cylindrical coil support member 537 such that the coils 532 and 533 are vertically adjacent to each other in FIG. 26. The detection coil 532 is disposed on the near side of the developer 531 to detect a change in the magnetic permeability, and the reference coil 533 is disposed on the far side of the developer 531 so that the magnetic permeability does not change even when the toner concentration changes.

(5) Charging Potential

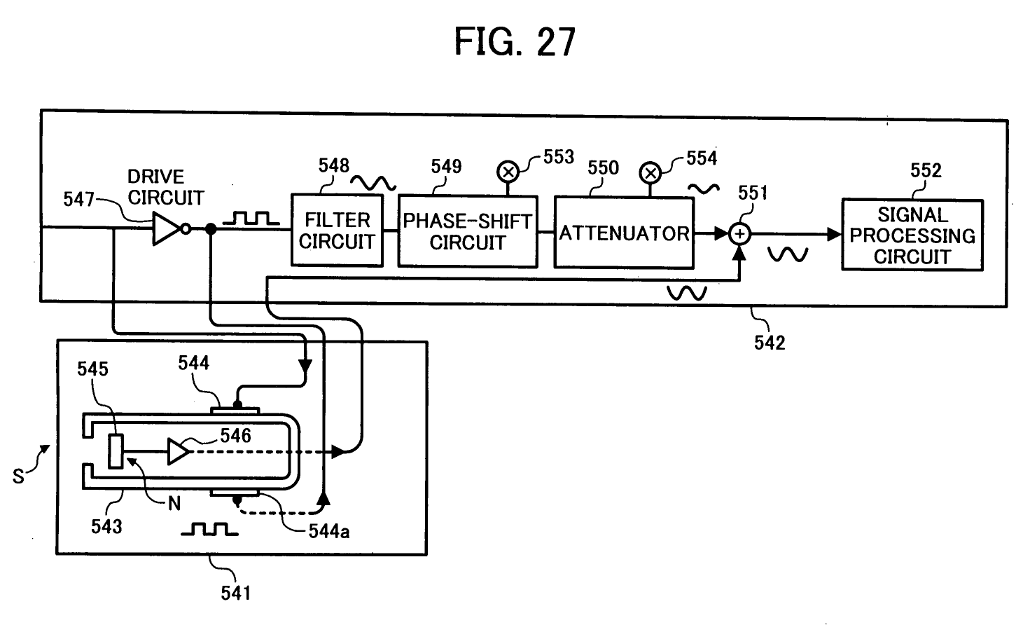

A charging potential is detected for each color in the photoreceptors 40K, 40Y, 40M, and 40C. FIG. 27 is a schematic diagram of a circuit configuration of a potential measuring system that detects a charging potential used in this embodiment. A sensor unit substrate 541 is attached opposite to an object (not shown). A signal processing unit substrate 542 transmits a drive signal to the sensor unit substrate 541 and receives a sensor output. The sensor unit substrate 541 includes a tuning fork 543 acting as a chopping unit and a piezoelectric element 544. The piezoelectric element 544 is driven by a drive signal from the signal processing unit substrate 542. In the potential measuring system, a self-excitation oscillation scheme using the following loop is used. When one piezoelectric element 544 is driven, the resulting oscillation is transmitted to another piezoelectric element 544a through the tuning fork 543, and then returns to the drive source. A measurement electrode 545 receives an electric line of force from the object. An amplifier 546 amplifies a temporal change in an electric line of force S received by the measurement electrode 545.

The signal processing unit substrate 542 includes a piezoelectric element drive circuit 547, a filter circuit 548, and a phase-shift circuit 549. The filter circuit 548 shapes a waveform. The phase-shift circuit 549 shifts a phase difference between a drive signal fed into in the sensor and an actual drive signal by 180 degrees so that they cancel each other out. The phase difference between the two signals generally changes depending on a feed path. An attenuator 550 adjusts the size of a phase-adjusted correction signal. An adding circuit 551 adds the correction signal to the sensor output. A signal processing circuit 552 processes a final signal output, and thus determines a potential of an object. Reference numerals 553 and 554 denote adjusting volumes of the phase-shift circuit and the attenuator, respectively.

With this configuration, an amount of phase shift and an attenuator gain are optimized such that an opposite phase and a signal of the same level can be added as a correction signal, thus enabling only a sensor output based on an actual object to be detected. Further, by providing an adjustment unit, characteristic change accompanying change over time can be dealt with by adjustment, and thus the reliability of the sensor is enhanced.

(6) LD Drive Current

The drive current value of a laser diode (LD) that performs image exposure is monitored according to color on a drive circuit, and used.

(7) Total Counter (Cumulative Number of Print Screens Per Color)

Cumulative data obtained by counting the number of print screens for each color is used. For example, when one image is formed in a full color mode, each of the numbers of Y, M, C, and Bk print screens is incremented by one. When one image is formed in a monochromatic (black) mode, only the number of Bk print screen is incremented by one. In Y and M modes, the numbers of Y and M print screens are incremented by one each. These data are stored in a storage element, and the results are used.

(8) Development γ Value

A gradual latent image potential is formed on a photoreceptor in a test mode, and the latent image is developed under a specific condition to form a gradual density pattern. A reflection density sensor reads the density pattern, and a relationship between a potential (potential difference) and the reflection density of the density pattern is calculated. The gradient of the relationship is set as a γ value. This γ value is calculated for each color, and used.

(9) Development Start Voltage

The relationship between the potential and the reflection density of the density pattern is calculated in the test mode described above, and a potential at which development reaches zero is calculated by extrapolation. The result is set as a development start voltage. This value is calculated for each color and used.

(10) Ratio of Colored Area

From input image information, a ratio of colored area is calculated for each color based on a ratio of a cumulative value of pixels to be colored and a cumulative value of all the pixels.

(11) Transfer Voltage

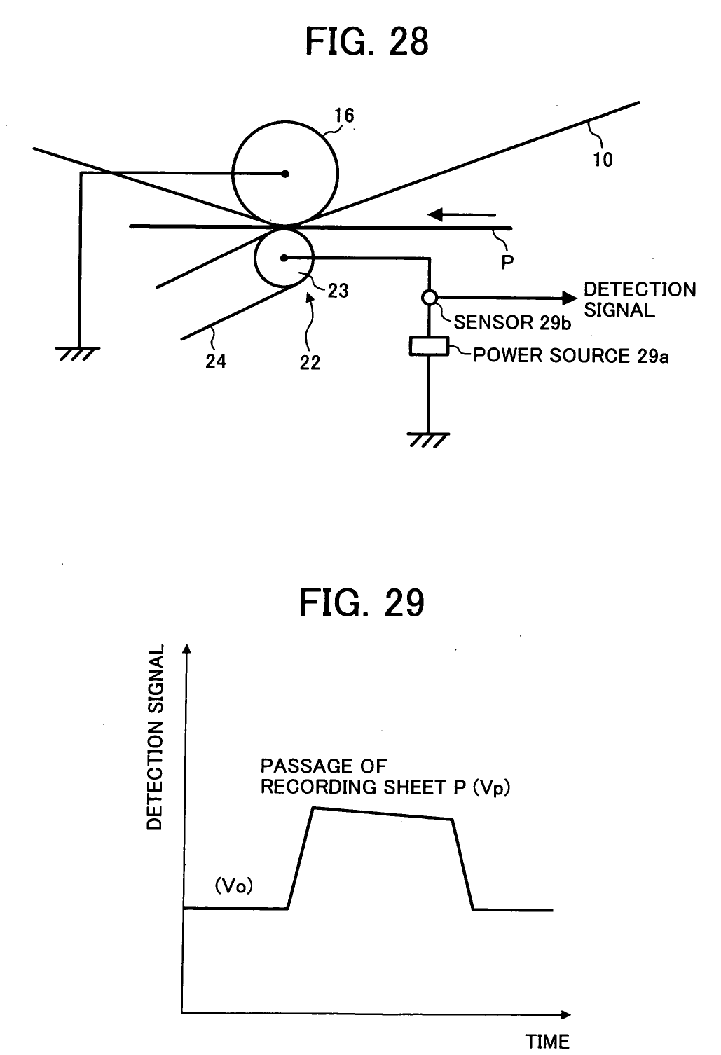

A transfer step for transferring a toner image from a photoreceptor or an intermediate transfer element to the recording sheet P is efficiently performed by forming an adequate electric field under the condition that the toner image is brought into contact with the recording sheet P and by urging the toner image to move to the recording sheet P. As an example of a method of transferring a toner image, a roller transfer method has been often used. The image forming apparatus of FIG. 1 uses the roller transfer method as illustrated in FIG. 28. In the secondary transfer device 22 of FIG. 28, a transfer voltage is applied to the secondary transfer roller 23 from a power source 29a, and thereby the full-color toner image is transferred from the intermediate transfer belt 10 to the recording sheet P. To maintain an adequate electric field, a transfer voltage to be applied from the power source 29a to the secondary transfer roller 23 needs to be controlled according to an electrical characteristic of the recording sheet P, such as permittivity, thickness, and resistance of the recording sheet P. As a non-limiting example, the transfer voltage is subjected to a constant-current control such that a value of current flowing from the secondary transfer roller 23 to the intermediate transfer belt 10 becomes constant. In the secondary transfer device 22, a transfer voltage (Vₚ) applied to the secondary transfer roller 23 during a period of the passage of the recording sheet P through the secondary transfer nip part formed between the intermediate transfer belt 10 and the secondary transfer roller 23, is detected by a transfer voltage detecting unit 29b, and the transfer voltage detecting unit 29b outputs a detection signal. Because the detection signal is in correlation with the characteristic of the recording sheet P, information related to the characteristic of the recording sheet P passing through the secondary transfer nip part can be obtained as sensing information. The obtained information related to the characteristic of the recording sheet P is used for predicting an occurrence of a sheet jam in the secondary transfer device 22, the fixing device 25, or any other places in the image forming apparatus. In view of the variation in electric resistance of the secondary transfer roller 23 caused by environmental fluctuations in temperature or humidity, a transfer voltage (Vo) applied to the secondary transfer roller 23 during a period of the non-passage of the recording sheet P is also detected by the transfer voltage detecting unit 29b. This detection signal is helpful in enhancing the accuracy of the information related to the state of the recording sheet P. FIG. 29 is a graph showing the change of the transfer voltage applied to the secondary transfer roller 23 according to the passage of the recording sheet P.

Instead of detecting the transfer voltage subjected to the constant-current control, a control signal output from a controller (not shown), such as, for example, a microcomputer for controlling a transfer voltage to be applied from the power source 29 may be detected as a detection signal to obtain the information related to the characteristic of the recording sheet P.

As plural types of the sensing information “a” shown in the block diagram of FIG. 14, detection information obtained by the recording medium abnormal track detecting unit, the recording medium abnormal conveyance time detecting unit, the recording medium rigidity detecting unit, and the recording medium thickness detecting unit may be input to the index value calculation unit 3. By calculating the index value “D” based on detection information having some relation to an occurrence of a sheet jam based on statistical experimental data and based on detection information having a clear causal relation to an occurrence of a sheet jam, the accuracy of the prediction of an occurrence of a sheet jam is enhanced.

In the above-described embodiment, an occurrence of a sheet jam is predicted by using a data mining technique for predicting an occurrence of abnormality by calculating an index value such as the “Mahalanobis distance” based on various types of related information. However, other techniques, such as a data mining technique using other calculation methods, an artificial intelligence (AI) technique, or the like, may be used to predict an occurrence of a sheet jam.

According to the above-described embodiment, plural types of information related to a state of an image forming apparatus are obtained, and an index value is calculated from the obtained plural types of information. The present inventors examined a relationship between a temporal change in the calculated index value and a state change occurring when the image forming apparatus is set in a sheet jam state, through experiments. It was found that the temporal change in the index value calculated from the plural types of information corresponded to the state change of the image forming apparatus. In addition, it was found that, if the index value was different from a value obtained in an initial normal state by a predetermined amount or more, a sheet jam occurred in the image forming apparatus. Therefore, by determining the change of the subsequent state of the image forming apparatus based on the data of the temporal change in the index value, an occurrence of a sheet jam can be predicted.

According to the above-described embodiment, because the index value “D” is calculated from plural types of information, an overall state change of the image forming apparatus can be determined from the temporal change in the index value “D”. Thus, an occurrence of a sheet jam can be predicted, even though a cause of such a sheet jam in the image forming apparatus is unclear. Further, an occurrence of a sheet jam can be predicted based on a temporal change of a single index value “D”. Therefore, data processing to predict an occurrence of a sheet jam can be simplified.

In the above-described embodiment, the plural types of information used for calculating the index value “D” may include at least one of a detection value obtained by a sensor provided in the printer unit 100, a control parameter used for controlling the image forming apparatus, and information related to an input image that is subjected to image formation. By calculating the index value “D” from these information, the state change of the image forming apparatus can be determined with accuracy, and an occurrence of a sheet jam can be predicted with high accuracy.

In the above-described embodiment, a calculation method for calculating the index value “D”, that is, a calculation expression for the index value “D” may be determined based on plural types of information obtained during an operation of the image forming apparatus in a normal state. In this case, explicit criteria for determining the state change of the image forming apparatus can be obtained. Thus, the state change of the image forming apparatus can be determined with accuracy, and an occurrence of a sheet jam can be predicted with high accuracy.

The image forming apparatus according to the embodiment may include an index value data display unit that displays the data related to temporal change in the index value “D”. Thus, a user can recognize the state change of the image forming apparatus and predict an occurrence of a sheet jam. Consequently, maintenance can be performed prior to an occurrence of a sheet jam.

In the embodiment, a calculation method for calculating the index value “D”, that is, a calculation expression for the index value “D” may be determined by the following procedures (1) to (5): “n” groups of “k” types
(1) Obtain “n” groups of “k” types of information selected in advance as plural types of information while operating the image forming apparatus;
(2) Normalize the (k X n) pieces of information obtained according to types by using average values and standard deviations of the pieces of information;
(3) Calculate correlation coefficients of all the combinations of the normalized (k X n) pieces of information;
(4) Calculate an inverse matrix of a (k X k) matrix that includes all correlation coefficients as elements; and
(5) Define the calculation method (calculation expression) by using all the elements of the inverse matrix.

In this calculation method, the obtained (k X n) pieces of information are normalized according to types by using the average values and the standard deviations to reduce an influence of the fluctuations of statistical data.

The values of the elements of the inverse matrix used in determining the calculation method (calculation expression) become great when the values are closely related to the state change of the image forming apparatus. Using the elements of the inverse matrix, the index value “D” can be calculated with a weight, which increases in proportion to the relativity between the state change and the correlation among the various types of information. Therefore, the state change of the image forming apparatus can be determined with higher accuracy.

Thus, an occurrence of a sheet jam in the image forming apparatus can be predicted with higher accuracy.

In the process of determining the calculation method (calculation expression) described in (1) to (5), the “n” groups of information may be obtained from one image forming apparatus in a time-series manner. In this case, pieces of information used in determining the index value calculation expression can be obtained by using a plurality of image forming apparatuses for one test. Thus, developing costs can be reduced.

Alternatively, in the process of determining the calculation method (calculation expression) described in (1) to (5), the “n” groups of information may be obtained in parallel from a plurality of image forming apparatuses. In this case, information obtainment for the determination of the calculation method (calculation expression) of the index value can be performed in parallel using a plurality of image forming apparatuses of the same type. Thus, development time can be reduced.

In the above-described embodiment, data of temporal changes of pieces of information obtained in advance with regard to different types of sheet jams in the image forming apparatus may be stored in an information storage unit in association with the contents of the sheet jams. When the index value “D” calculated by the index value calculation unit 3 is greater than a predetermined reference value, the content of a sheet jam, which is expected to occur thereafter, may be specified based on the subsequent temporal changes of the pieces of information and the pieces of information stored in the information storage unit. In this case, because the content of the sheet jam can be specified based on the temporal change of the pieces of information, prediction accuracy of an occurrence of a sheet jam can be enhanced, and appropriate maintenance can be performed before occurrence of the sheet jam.

The information storage unit may be a memory such as a RAM included in the control unit 5. A sheet jam content specifying unit that specifies the content of a sheet jam may be a CPU or the like, included in the control unit 5. The information storage unit and the sheet jam content specifying unit may be configured by devices including exclusive large-scale integrated (LSI) circuits disposed independently of the control unit 5. Instead of the content of the sheet jam, the content of maintenance performed when the sheet jam occurs may be associated with the temporal changes of the pieces of information. Alternatively, both the content of the sheet jam and content of the maintenance performed when the sheet jam occurs may be associated with the temporal changes of the pieces of information.

In the above-described embodiment, a state determining apparatus including a communication unit may be disposed outside the image forming apparatus. The communication unit may receive the pieces of information used in calculation of the index value “D” from the image forming apparatus through a communication network such as a single-purpose network, a public network, the Internet, or a local area network. Thus, the configuration of the image forming apparatus can be simplified. Further, a determination of a state change or prediction of an occurrence of a sheet jam in the image forming apparatuses can be performed collectively by a monitoring center or the like, in which the state determining apparatus is installed.

In the above-described embodiment, the control unit 5 may control the image forming system 6 based on the temporal change in the index value “D”. In this case, the image forming system 6 can be rapidly controlled such that the state change of the image forming apparatus is determined to predict an occurrence of a sheet jam. Thus, an occurrence of a serious failure can be avoided.

According to the embodiment, the present invention is effectively applied to an electrophotographic image forming apparatus including the following processes: a latent image is formed on an image carrier (the photoreceptors 40K, 40Y, 40M, 40C); the latent image on the image carrier is developed with toner to form a toner image; and the toner image formed is transferred to a recording medium directly or through an intermediate transfer element (the intermediate transfer belt 10). The electrophotographic image forming apparatus has the following characteristic features: (1) the image forming apparatus includes a large number of construction elements, and causal association of phenomena is complex; (2) the image forming apparatus is easily affected by environmental conditions such as temperature or humidity; (3) consumable parts such as units and components easily deteriorate; and (4) ambient operating conditions largely change depending on users. Although the complex configuration and phenomenon described above intervene in the image forming apparatus, an occurrence of a sheet jam the cause of which is not clear, can be predicted by simple data processing.

The image forming apparatus according to the embodiment may include a jam prediction result display unit that displays a prediction result of an occurrence of a sheet jam. Thus, a user can recognize the occurrence of the sheet jam from the information displayed. Consequently, maintenance can be performed prior to an occurrence of a sheet jam.

The image forming apparatus according to the embodiment may include a communication unit that transmits a prediction result of an occurrence of a sheet jam to an external apparatus through a communication network such as a single-purpose network, a public network, the Internet, or a local area network. In this case, prediction of an occurrence of a sheet jam in a plurality of image forming apparatuses can be collectively performed by a monitoring center or the like.

In the image forming apparatus according to the embodiment, the control unit 5 may control the image forming system 6 based on a prediction result of an occurrence of a sheet jam, to restrict an image forming operation. In this case, a specific operation is temporarily restricted, depending on the prediction result, to avoid an occurrence of a serious failure.

In the image forming apparatus according to the embodiment, the control unit 5 may execute a repair control mode to repair a sheet jam state based on the prediction result. Thus, an occurrence of a serious failure can be avoided.

In the image forming apparatus according to the embodiment, a calculation method for the index value “D” may be determined each time an operation of the image forming apparatus is started. Thus, even though correlation between pieces of information of different types obtained with respect to the image forming apparatus and relation between the correlation and an occurrence of a sheet jam vary, a determination of a state change and prediction of an occurrence of a sheet jam can be highly accurate.

In the image forming apparatus according to the embodiment, even though causal association of phenomena is unclear, an occurrence of a sheet jam can be predicted based on phenomena seemed to have statistical causes.

According to the above-described embodiments of the present invention, because an occurrence of a conveyance failure such as a sheet jam can be predicted, necessary maintenance can be performed in advance, thereby reducing a time loss for a user.

The present invention has been described with respect to the exemplary embodiments illustrated in the figures. However, the present invention is not limited to these embodiments and may be practiced otherwise.

Numerous additional modifications and variations of the present invention are possible in light of the above teachings. It is therefore to be understood that within the scope of the appended claims, the present invention may be practiced otherwise than as specifically described herein.

1. A recording medium conveyance failure occurrence predicting apparatus configured to predict an occurrence of a conveyance failure of a recording medium conveyed in a conveyance path in an image forming apparatus including a recording medium conveyance unit including a record medium conveyance member configured to come into contact with the recording medium while moving the recording medium, the record medium conveyance unit further including a separation portion configured to provide normal separation of the recording medium from the recording medium conveyance member with resulting recording medium movement along a desired track, the recording medium conveyance failure occurrence predicting apparatus comprising:
a recording medium abnormal separation detecting unit configured to detect an abnormal separation or lack of separation of the recording medium from the recording medium conveyance member such that recording medium movement is not along the desired track; and
a determining unit configured to predict a probable future abnormal separation or lack of separation of the recording medium from the recording medium conveyance member based at least on a detection result of the recording medium abnormal separation detecting unit.

2. The recording medium conveyance failure occurrence predicting apparatus according to claim 1, further comprising:
a storage unit configured to store the detection result of the recording medium abnormal separation detecting unit, the detection result including at least one of an occurrence number and an occurrence rate of the abnormal separation or lack of separation.

3. The recording medium conveyance failure occurrences predicting apparatus according to claim 1, wherein the recording medium abnormal separation detecting unit comprises a recording medium abnormal track detecting unit configured to detect an abnormal track of the recording medium.

4. The recording medium conveyance failure occurrence predicting apparatus according to claim 3, wherein the record medium conveyance unit further comprises:
a contact-type recording medium separating member configured to separate the recording medium, which has not been normally separated from the recording medium conveyance member at the separation portion, from the recording medium conveyance member, the contact type recording medium separating member contacting a surface of the recording medium conveyance member on a downstream side of the separation portion in a surface moving direction of the recording medium conveyance member, wherein the recording medium abnormal track detecting unit comprises a contact-type separation detecting member configured to detect a contact of the contact-type recording medium separating member and the recording medium.

5. The recording medium conveyance failure occurrence predicting apparatus according to claim 3, wherein the record medium conveyance unit further comprises:
a non-contact-type recording medium separating member configured to separate the recording medium, which has not been normally separated from the recording medium conveyance member at the separation portion, from the recording medium conveyance member, the non-contact-type recording medium separating member being disposed adjacent to a surface of the recording medium conveyance member on a downstream side of the separation portion in a surface moving direction of the recording medium conveyance member, wherein the recording medium abnormal track detecting unit comprises a non-contact-type separation detecting member configured to detect a contact of the non-contact-type recording medium separating member and the recording medium.

6. The recording medium conveyance failure occurrence predicting apparatus according to claim 3, wherein the recording medium abnormal track detecting unit comprises a light reflection sensor including a light emitting portion and a light receiving portion, the light reflection sensor being configured to detect the recording medium when a light emitted from the light emitting portion is reflected from the recording medium and the light reflected from the recording medium enters the light receiving portion.

7. The recording medium conveyance failure occurrence predicting apparatus according to claim 3, wherein the recording medium abnormal track detecting unit comprises a light transmission sensor including a light emitting portion and a light receiving portion, the light transmission sensor being configured to detect the recording medium when a light emitted from the light emitting portion is interrupted by the recording medium and the light emitted from the light emitting portion does not enter the light receiving portion.

8. The recording medium conveyance failure occurrence predicting apparatus according to claim 3, wherein the record medium conveyance unit further comprises:
a recording medium thickness detecting unit configured to detect a thickness of the recording medium,
wherein the determining unit is further configured to predict the probable future abnormal separation or lack of separation of the recording medium from the record medium conveyance member based on the detection result of the recording medium abnormal track detecting unit and a detection result of the recording medium thickness detecting unit.

9. The recording medium conveyance failure occurrence predicting apparatus according to claim 3, wherein the record medium conveyance unit further comprises:
a recording medium rigidity detecting unit configured to detect a rigidity of the recording medium,
wherein the determining unit is further configured to predict the probable future abnormal separation or lack of separation of the recording medium from the record medium conveyance member based on the detection result of the recording medium abnormal track detecting unit and a detection result of the recording medium rigidity detecting unit.

10. The recording medium conveyance failure occurrence predicting apparatus according to claim 1,
wherein the recording medium abnormal separation detecting unit comprises:
a recording medium abnormal conveyance time detecting unit configured to detect an abnormality in a conveyance time of the recording medium; and
a recording medium rigidity detecting unit configured to detect a rigidity of the recording medium.

11. The recording medium conveyance failure occurrence predicting apparatus according to claim 1,
wherein the recording medium abnormal separation detecting unit comprises:
a recording medium abnormal conveyance time detecting unit configured to detect an abnormality in a conveyance time of the recording medium; and
a recording medium thickness detecting unit configured to detect a thickness of the recording medium.

12. The recording medium conveyance failure occurrence predicting apparatus according to claim 1,
wherein the recording medium conveyance member is further configured as a fixing member configured to fix an image on the recording medium by contacting and heating the recording medium carrying the image.

13. The recording medium conveyance failure occurrence predicting apparatus according to claim 1,
wherein the recording medium conveyance member is further configured as an image carrier configured to carry an image on a surface of the image carrier, and
the image is transferred from the surface of the image carrier to a surface of the recording medium conveyed by a movement of the image carrier.

14. The recording medium conveyance failure occurrence predicting apparatus according to-claim 12,
wherein the determining unit is further configured to predict the probable future abnormal separation or lack of separation of the recording medium from the record medium conveying member based on image information of the image.

15. The recording medium conveyance failure occurrence predicting apparatus according to claim 13,
wherein the determining unit is further configured to predict the probable future abnormal separation or lack of separation of the recording medium from the recording medium conveying member based on image information of the image.

16. A recording medium conveyance failure occurrence predicting apparatus configured to predict an occurrence of a conveyance failure of a recording medium conveyed in a conveyance path in an image forming apparatus including a recording medium conveyance unit including a recording medium conveyance member configured to come into contact with the recording medium while moving the recording medium, the recording medium conveyance unit further including a separation portion configured to provide normal separation of the recording medium from the recording medium conveyance member with resulting recording medium movement along a desired track, the recording medium conveyance failure occurrence predicting apparatus comprising:
an information obtaining unit configured to obtain plural types of information related to a state of the image forming apparatus;
an index value calculating unit configured to calculate an index value based on the plural types of information obtained by the information obtaining unit; and
a determining unit configured to predict a probable future abnormal separation or lack of separation of the recording medium from the recording medium conveyance member based at least on data of a temporal change in the index value calculated by the index value calculating unit.

17. The recording medium conveyance failure occurrence predicting apparatus according to claim 16, further comprising:
a recording medium abnormal track detecting unit configured to detect an abnormal track of the recording medium,
wherein the plural types of information include a detection result of the recording medium abnormal track detecting unit.

18. The recording medium conveyance failure occurrence predicting apparatus according to claim 16, further comprising:
a recording medium abnormal conveyance time detecting unit configured to detect an abnormality in a conveyance time of the recording medium;
wherein the plural types of information include a detection result of the recording medium abnormal conveyance time detecting unit.

19. The recording medium conveyance failure occurrence predicting apparatus according to claim 16,
wherein the recording medium conveyance member is further configured as a fixing member configured to fix an image on the recording medium by contacting and heating the recording medium carrying the image.

20. The recording medium conveyance failure occurrence predicting apparatus according to claim 16,
wherein the recording medium conveyance member is further configured as an image carrier configured to carry an image on a surface of the image carrier, and.
the image is transferred from the surface of the image carrier to a surface of the recording medium conveyed by a movement of the image carrier, by applying a transfer voltage to a transfer member.

21. The recording medium conveyance failure occurrence predicting apparatus according to claim 20, further comprising;
a transfer voltage detecting unit configured to detect the transfer voltage applied to the transfer member, wherein the transfer voltage is subjected to a constant current control such that a value of current flowing from the transfer member to the image carrier becomes constant, and
the plural types of information include a detection result of the transfer voltage detecting unit.

22. An image forming apparatus, comprising:
an image forming device configured to form an image on a recording medium;
a recording medium conveyance member configured to contact and move the recording medium while moving and contacting the recording medium;
a separation portion configured to provide normal separation of the recording medium from the recording medium conveyance member;
a conveyance path, including the separation portion, through which the recording medium is conveyed by the recording medium conveyance member; and
a recording medium conveyance failure occurrence predicting apparatus configured to predict an occurrence of a conveyance failure of the recording medium conveyed in the conveyance path, the recording medium conveyance failure occurrence predicting apparatus comprising:
a recording medium abnormal separation detecting unit configured to detect an abnormal separation or lack of separation of the recording medium from the recording medium conveyance member; and
a determining unit configured to predict a probable future abnormal separation or lack of separation of the recording medium from the recording medium conveyance member based at least on a detection result of the recording medium abnormal separation detecting unit.

23. The image forming apparatus according to claim 22, wherein the recording medium conveyance failure occurrence predicting apparatus further comprises:
a storage unit configured to store the detection result of the recording medium abnormal separation detecting unit, the detection result including at least one of an occurrence number and an occurrence rate of the abnormal separation or lack of separation.

24. The image forming apparatus according to claim 22, wherein the recording medium abnormal separation detecting unit includes a recording medium abnormal track detecting unit configured to detect an abnormal track of the recording medium.

25. The image forming apparatus according to claim 24, wherein the recording medium conveyance failure occurrence predicting apparatus further comprises:
a contact-type recording medium separating member configured to separate the recording medium, which has not been normally separated from the recording medium conveyance member at the separation portion, from the recording medium conveyance member, the contact type recording medium separating member contacting a surface of the recording medium conveyance member on a downstream side of the separation portion in a surface moving direction of the recording medium conveyance member, wherein the recording medium abnormal track detecting unit comprises a contact-type separation detecting member configured to detect a contact of the contact-type recording medium separating member and the recording medium.

26. The image forming apparatus according to claim 24, wherein the recording medium conveyance failure occurrence predicting apparatus further comprises:
a non-contact-type recording medium separating member configured to separate the recording medium, which has not been normally separated from the recording medium conveyance member at the separation portion, from the recording medium conveyance member, the non-contact-type recording medium separating member being disposed adjacent to a surface of the recording medium conveyance member on a downstream side of the separation portion in a surface moving direction of the recording medium conveyance member, wherein the recording medium abnormal track detecting unit comprises a non-contact-type separation detecting member configured to detect a contact of the non-contact-type recording medium separating member and the recording medium.

27. The image forming apparatus according to claim 24,
wherein the recording medium abnormal track detecting unit comprises a light reflection sensor including a light emitting portion and a light receiving portion, the light reflection sensor being configured to detect the recording medium when a light emitted from the light emitting portion is reflected from the recording medium and the light reflected from the recording medium enters the light receiving portion.

28. The image forming apparatus according to claim 24,
wherein the recording medium abnormal track detecting unit comprises a light transmission sensor that includes a light emitting portion and a light receiving portion, the light transmission sensor being configured to detect the recording medium when a light emitted from the light emitting portion is interrupted by the recording medium and the light emitted from the light emitting portion does not enter the light receiving portion.

29. The image forming apparatus according to claim 24, wherein the recording medium conveyance failure occurrence predicting apparatus further comprises:
a recording medium thickness detecting unit configured to detect a thickness of the recording medium,
wherein the determining unit is further configured to predict the probable future abnormal separation or lack of separation of the recording medium from the recording medium conveyance member based on the detection result of the recording medium abnormal track detecting unit and a detection result of the recording medium thickness detecting unit.

30. The image forming apparatus according to claim 24, wherein the recording medium conveyance failure occurrence predicting apparatus further comprises:
a recording medium rigidity detecting unit configured to detect a rigidity of the recording medium,
wherein the determining unit is further configured to predict the probable future abnormal separation or lack of separation of the recording medium from the recording medium conveyance member based on the detection result of the recording medium abnormal track detecting unit and a detection result of the recording medium rigidity detecting unit.

31. The image forming apparatus according to claim 22,
wherein the recording medium abnormal separation detecting unit comprises:
a recording medium abnormal conveyance time detecting unit configured to detect an abnormality in a conveyance time of the recording medium; and
a recording medium rigidity detecting unit configured to detect a rigidity of the recording medium.

32. The image forming apparatus according to claim 22, wherein the recording medium abnormal separation detecting unit comprises:
a recording medium abnormal conveyance time detecting unit s configured to detect an abnormality in a conveyance time of the recording medium; and
a recording medium thickness detecting unit configured to detect a thickness of the recording medium.

33. The image forming apparatus according to claim 22,
wherein the recording medium conveyance member is further configured as a fixing member configured to fix an image on the recording medium by contacting and heating the recording medium carrying the image.

34. The image forming apparatus according to claim 22, wherein the recording medium conveyance member is further configured as an image carrier configured to carry an image on a surface of the image carrier, and
the image is transferred from the surface of the image carrier to a surface of the recording medium conveyed by a movement of the image carrier.

35. The image forming apparatus according to claim 33,
wherein the determining unit is further configured to predict the probable future abnormal separation or lack of separation of the recording medium from the recording medium conveying member based on image information of the image.

36. The image forming apparatus according to claim 34,
wherein the determining unit is further configured to predict the probable future abnormal separation or lack of separation of the recording medium from the recording medium conveyance member based on image information of the image.

37. An image forming apparatus, comprising:
an image forming device configured to form an image on a recording medium;
a recording medium conveyance member configured to come into contact with and to convey the recording medium;
a separation portion configured to provide normal separation of the recording medium from the recording medium conveyance member;
a conveyance path, including the separation portion, through which the recording medium is conveyed by the recording medium conveyance member; and
a recording medium conveyance failure occurrence predicting apparatus configured to predict an occurrence of a conveyance failure of the recording medium conveyed in the conveyance path, the recording medium conveyance failure occurrence predicting apparatus comprising:
an information obtaining unit configured to obtain plural types of information related to a state of the image forming apparatus;
an index value calculating unit configured to calculate an index value based on the plural types of information obtained by the information obtaining unit; and
a determining unit configured to predict a probable future abnormal separation or lack of separation of the recording medium from the recording medium conveyance member based at least on data of a temporal change in the index value calculated by the index value calculating unit.

38. The image forming apparatus according to claim 37,
wherein the recording medium conveyance failure occurrence predicting apparatus further comprises:
a recording medium abnormal track detecting unit configured to detect an abnormal track of the recording medium,
wherein the plural types of information include a detection result of the recording medium abnormal track detecting unit.

39. The image forming apparatus according to claim 37,
wherein the recording medium conveyance failure occurrence predicting apparatus further comprises:
a recording medium abnormal conveyance time detecting unit configured to detect an abnormality in a conveyance time of the recording medium;
wherein the plural types of information include a detection result of the recording medium abnormal conveyance time detecting unit.

40. The image forming apparatus according to claim 37,
wherein the recording medium conveyance member is further configured as a fixing member configured to fix an image on the recording medium by contacting and heating the recording medium carrying the image.

41. The image forming apparatus according to claim 37,
wherein the recording medium conveyance member is further configured as an image carrier configured to carry an image on a surface of the image carrier, and
the image is transferred from the surface of the image carrier to a surface of the recording medium conveyed by a movement of the image carrier, by applying a transfer voltage to a transfer member.

42. The image forming apparatus according to claim 41,
wherein the recording medium conveyance failure occurrence predicting apparatus further comprises:
a transfer voltage detecting unit configured to detect the transfer voltage applied to the transfer member, wherein the transfer voltage is subjected to a constant current control such that a value of current flowing from the transfer member to the image carrier becomes constant, and
the plural types of information include a detection result of the transfer voltage detecting unit.

43. A fixing device, comprising:
a fixing unit including a first moving element and a second moving element forming a nip part between the first and second moving elements, the fixing unit being configured to fix an image carried on a recording medium at the nip part by heat and pressure; and
a recording medium abnormal track detecting unit configured to detect an abnormal track of a leading edge of the recording medium on a downstream side of the nip part in a surface moving direction of the first and second moving elements.

44. The fixing device according to claim 43, further comprising:
a separation portion configured to provide normal separation of the recording medium from between the first and second moving elements after passing through the nip part; and
a contact-type recording medium separating member configured to separate the recording medium, which has not been normally separated from the first moving element at the separation portion, from the first moving element, the contact-type recording medium separating member contacting a surface of the first moving element,
wherein the recording medium abnormal track detecting unit comprises a contact-type separation detecting member configured to detect a contact of the contact-type recording medium separating member and the recording medium.

45. The fixing device according to claim 43, further comprising:
a separation portion configured to provide normal separation of the recording medium from between the first and second moving elements after passing through the nip part; and
a non-contact-type recording medium separating member configured to separate the recording medium, which has not been normally separated from the first moving element at the separation portion, from the first moving element, the non-contact-type recording medium separating member being disposed adjacent to a surface of the first moving element, wherein the recording medium abnormal track detecting unit comprises a non-contact-type separation detecting member configured to detect a contact of the non-contact-type recording medium separating member and the recording medium.

46. The fixing device according to claim 43,
wherein the recording medium abnormal track detecting unit comprises a light reflection sensor including a light emitting portion and a light receiving portion, the light reflection sensor being configured to detect the recording medium when a light emitted from the light emitting portion is reflected from the recording medium and the light reflected from the recording medium enters the light receiving portion.

47. The fixing device according to claim 43, wherein the recording medium abnormal track detecting unit comprises a light transmission sensor including a light emitting portion and a light receiving portion, the light transmission sensor being configured to detect the recording medium when a light emitted from the light emitting portion is interrupted by the recording medium and the light emitted from the light emitting portion does not enter the light receiving portion.

48. An image forming apparatus, comprising:
an image carrier configured to carry an image on the image carrier;
a latent image forming device configured to form a latent image on the image carrier;
a developing device configured to develop the latent image with toner to form a toner image;
a transfer device configured to transfer the toner image to a recording medium either directly from the image carrier or indirectly through an intermediate transfer element; and
a fixing device configured to fix the toner image to the recording medium, the fixing device comprising:
a fixing unit including a first moving element and a second moving element forming a nip part between the first and second moving elements, the fixing unit being configured to fix the toner image to the recording medium at the nip part by heat and pressure; and
a recording medium abnormal track detecting unit configured to detect an abnormal track of a leading edge of the recording medium on a downstream side of the nip part in a surface moving direction of the first and, second moving elements.

49. The image forming apparatus according to claim 48, wherein the fixing device further comprises:
a separation portion configured to provide normal separation of the recording medium from between the first and second moving elements after passing through the nip part; and
a contact-type recording medium separating member configured to separate the recording medium, which has not been normally separated from the first moving element at the separation portion, from the first moving element, the contact-type recording medium separating member contacting a surface of the first moving element,
wherein the recording medium abnormal track detecting unit comprises a contact-type separation detecting member configured to detect a contact of the contact-type recording medium separating member and the recording medium.

50. The image forming apparatus according to claim 48,
wherein the fixing device further comprises:
a separation portion configured to provide normal separation of the recording medium from between the first and second moving elements after passing through the nip part; and
a non-contact-type recording medium separating member configured to separate the recording medium, which has not been normally separated from the first moving element in the separation portion, from the first moving element, the non-contact-type recording medium separating member being disposed adjacent to a surface of the first moving element,
wherein the recording medium abnormal track detecting unit comprises a non-contact-type separation detecting member configured to detect a contact of the non-contact-type recording medium separating member and the recording medium.

51. The image forming apparatus according to claim 48,
wherein the recording medium abnormal track detecting unit comprises a light reflection sensor including a light emitting portion and a light receiving portion, the light reflection sensor being configured to detect the recording medium when a light emitted from the light emitting portion is reflected from the recording medium and the light reflected from the recording medium enters the light receiving portion.

52. The image forming apparatus according to claim 48, wherein the recording medium abnormal track detecting unit comprises a light transmission sensor including a light emitting portion and a light receiving portion, the light transmission sensor being configured to detect the recording medium when a light emitted from the light emitting portion is interrupted by the recording medium and the light emitted from the light emitting portion does not enter the light receiving portion.

53. An image forming apparatus, comprising:
means for forming an image on a recording medium;
means for conveying the recording medium;
a separation portion configured to provide normal separation of the recording medium from the means for conveying;
a conveyance path, including the separation portion, through which the recording medium is conveyed by the means for conveying; and
a recording medium conveyance failure occurrence predicting apparatus that predicts an occurrence of a conveyance failure of the recording medium conveyed in the conveyance path, the recording medium conveyance failure occurrence predicting apparatus comprising:
first means for detecting an abnormal separation or lack of separation of the recording medium from the means for conveying; and
means for predicting a probable future abnormal separation or lack of separation of the recording medium from the means for conveying based at least on a detection result of the first means for detecting.

54. The image forming apparatus according to claim 53, wherein the recording medium conveyance failure occurrence 20 predicting apparatus further comprises:
means for storing the detection result of the first means for detecting, the detection result including at least one of an occurrence number and an occurrence rate of the abnormal separation or lack of separation.

55. The image forming apparatus according to claim 53, wherein the first means for detecting includes second means for detecting an abnormal track of the recording medium.

56. The image forming apparatus according to claim 55, wherein the recording medium conveyance failure occurrence predicting apparatus further comprises:
contact separating means for separating the recording medium from the means for conveying by contacting a surface of the means for conveying on a downstream side of the separation portion in a surface moving direction of the means for conveying,
wherein the second means for detecting includes third means for detecting a contact of the contact separating means for separating and the recording medium.

57. The image forming apparatus according to claim 55, wherein the recording medium conveyance failure occurrence predicting apparatus further comprises:
further means for separating the recording medium from the means for conveying, the further means for separating being disposed adjacent to a surface of the means for conveying on a downstream side of the separation portion in a surface moving direction of the means for conveying,
wherein the second means for detecting further includes fourth means for detecting a contact of the further means for separating and the recording medium.

58. The image forming apparatus according to claim 55,
wherein the recording medium conveyance failure occurrence predicting apparatus further comprises:
fifth means for detecting a thickness of the recording medium,
wherein the means for predicting predicts the probable future abnormal separation or lack of separation of the recording medium from the means for conveying based on the detection result of the second means for detecting and a detection result of the fifth means for detecting.

59. The image forming apparatus according to claim 55, wherein the recording medium conveyance failure occurrence predicting apparatus further comprises:
sixth means for detecting a rigidity of the recording medium,
wherein the means for predicting predicts the probable future abnormal separation or lack of separation of the recording medium from the means for conveying based on the detection result of the second means for detecting and a detection result of the sixth means for detecting.

60. The image forming apparatus according to claim 53, wherein the first means for detecting includes:
seventh means for detecting an abnormality in a conveyance time of the recording medium; and
sixth means for detecting a rigidity of the recording medium.

61. The image forming apparatus according to claim 53, wherein the first means for detecting includes:
seventh means for detecting an abnormality in a conveyance time of the recording medium; and
fifth means for detecting a thickness of the recording medium.

62. The image forming apparatus according to claim 53,
wherein the means for conveying the recording medium further includes means for fixing an image on the recording medium by contacting and heating the recording medium carrying the image.

63. The image forming apparatus according to claim 53,
wherein the means for conveying the recording medium further includes means for carrying an image on a surface of the means for carrying an image, and the image is transferred from the surface of the means for carrying an image to a surface of the recording medium conveyed by a movement of the means for carrying an image.

64. An image forming apparatus, comprising:
means for forming an image on a recording medium;
means for conveying the recording medium;
a separation portion configured to provide normal separation of the recording medium from the means for conveying;
a conveyance path, including the separation portion, through which the recording medium is conveyed by the means for conveying; and
a recording medium conveyance failure occurrence predicting apparatus that predicts an occurrence of a conveyance failure of the recording medium conveyed in the conveyance path, the recording medium conveyance failure occurrence predicting apparatus comprising:
means for obtaining plural types of information related to a state of the image forming apparatus;
means for calculating an index value based on the plural types of information obtained by the means for obtaining; and
means for predicting a probable future abnormal separation or lack of separation of the recording medium from the means for conveying at the separation portion based at least on data of a temporal change in the index value calculated by the means for calculating.

65. The image forming apparatus according to claim 64, wherein the recording medium conveyance failure occurrence predicting apparatus further comprises:
means for detecting an abnormal track of the recording medium,
wherein the plural types of information include a detection result of the means for detecting.

66. The image forming apparatus according to claim 64, wherein the recording medium conveyance failure occurrence predicting apparatus further comprises:
means for detecting an abnormality in a conveyance time of the recording medium;
wherein the plural types of information include a detection result of the means for detecting.

67. The image forming apparatus according to claim 64,
wherein the means for conveying further includes means for fixing an image on the recording medium by contacting and heating the recording medium carrying the image.

68. The image forming apparatus according to claim 64,
wherein the means for conveying further includes means for carrying an image on a surface of the means for carrying, and
the image is transferred from the surface of the means for carrying an image to a surface of the recording medium conveyed by a movement of the means for carrying an image, by applying a transfer voltage to a transfer member.

69. The image forming apparatus according to claim 68, wherein the recording medium conveyance failure occurrence predicting apparatus further comprises:
means for detecting the transfer voltage applied to the transfer member,
wherein the transfer voltage is subjected to a constant current control such that a value of current flowing from the transfer member to the means for carrying an image becomes constant, and
the plural types of information include a detection result of the means for detecting.

70. An image forming apparatus, comprising:
means for carrying an image;
means for forming a latent image on the means for carrying an image;
means for developing the latent image with toner to form a toner image;
means for transferring the toner image to a recording medium either directly from the means for carrying or indirectly through an intermediate transfer element; and
means for fixing the toner image to the recording medium, the means for fixing comprising:
a fixing unit including a first moving element and a second moving element forming a nip part between the first and second moving elements, the fixing unit being configured to fix the toner image to the recording medium at the nip part by heat and pressure; and
means for detecting an abnormal track of a leading edge of the recording medium on a downstream side of the nip part in a surface moving direction of the first and second moving elements.

71. A method for predicting an occurrence of a conveyance failure of a recording medium conveyed in a conveyance path in an image forming apparatus, the method comprising:
detecting an abnormal separation or lack of separation of the recording medium from a recording medium conveyance member; and
predicting an occurrence of a conveyance failure of the recording medium based on a detection result obtained in the detecting step.

72. The method according to claim 71, wherein the detecting step includes detecting an abnormal track of the recording medium.

73. The method according to claim 72, wherein the detecting an abnormal track of the recording medium includes detecting a contact of a contact-type recording medium separating member and the recording medium.

74. The method according to claim 72, further comprising:
detecting a thickness of the recording medium,
wherein the predicting comprises predicting the occurrence of the conveyance failure of the recording medium based on the result of detecting an abnormal track of the recording medium and a detection result of detecting the thickness of the recording medium.

75. The method according to claim 72, further comprising:
detecting a rigidity of the recording medium,
wherein the predicting comprises predicting the occurrence of the conveyance failure of the recording medium based on the result of detecting an abnormal tracking of the recording medium and a result of detecting the rigidity of the recording medium.

76. The method according to claim 71,
wherein the detecting step further comprises:
detecting an abnormality in a conveyance time of the recording medium: and detecting a rigidity of the recording medium.

77. The method according to claim 71,
wherein the detecting step further comprises:
detecting an abnormality in a conveyance time of the recording medium; and
detecting a thickness of the recording medium.

78. A method for predicting an occurrence of a conveyance failure of a recording medium conveyed in a conveyance path in an image forming apparatus, the method comprising:
obtaining plural types of information related to a state of the image forming apparatus;
calculating an index value based on the plural types of information obtained in the obtaining step; and
predicting an occurrence of a conveyance failure of the recording medium based on data of a temporal change in the index value calculated in the calculating step.

79. The method according to claim 78, further comprising:
detecting an abnormal track of the recording medium,
wherein the plural types of information include a detection result obtained in the detecting step.

80. The method according to claim 78, further comprising:
detecting an abnormality in a conveyance time of the recording medium;
wherein the plural types of information include a detection result obtained in the detecting step.

81. The method according to claim 78, further comprising:
detecting a transfer voltage subjected to a constant-current control, and applied to a transfer member,
wherein the plural types of information include a detection result obtained in the detecting step.
